(19) United States
(12) Patent Application Publication
(10) Pub. No.: US 2025/0344688 A1
(43) Pub. Date: Nov. 13, 2025

(54) Spraying and Scouting Systems and Related Methods

(71) Applicant: AgTechLogic Inc., Phoenix, AZ (US)

(72) Inventors: Justin Hoffman, San Antonio, TX (US); Tom Gauthier, Phoenix, AZ (US); Zachary Greenberg, Scottsdale, AZ (US); Erik Barton, Santa Rosa, CA (US)

(21) Appl. No.: 19/204,401

(22) Filed: May 9, 2025

Related U.S. Application Data
(60) Provisional application No. 63/645,803, filed on May 10, 2024.
(60) Provisional application No. 63/648,099, filed on May 15, 2024.

(51) Int. Cl. A01M 7/00; A01B 79/00

(52) U.S. Cl. CPC A01M 7/0089; A01B 79/005; A01M 7/0014

(57) ABSTRACT

Implementations of a data acquisition unit for a ground vehicle may include an enclosure; a single board computer included in the enclosure; and a base board; operatively coupled with the single board computer. The data acquisition unit may include an optocoupler operatively coupled with the single board computer; at least one chlorophyll fluorescence sensor coupled with the optocoupler; at least one camera coupled to the base board; and a global positioning sensor coupled with the base board. The data acquisition unit may include a flow meter coupled with the single board computer; and a power source operatively coupled with the single board computer and with the base board.

### CROSS REFERENCE TO RELATED APPLICATIONS

This document claims the benefit of the filing date of U.S. Provisional Patent Application 63/645,803, ('803 Provisional) entitled “Herbicide Spraying and Weed Identification Systems and Related Methods” to Hoffman et al, which was filed on May 10, 2024, and also claims the benefit of U.S. Provisional Patent Application 63/648,099, ('099 Provisional) entitled “Ground Drone Precision Spraying Systems and Related Methods,” to Hoffman et al, which was filed on May 15, 2024, the disclosures of each of which are hereby incorporated entirely herein by reference.

### BACKGROUND

### 1. Technical Field

Aspects of this document relate generally to ground vehicles. More specific implementations involve vehicles used to spray herbicide, fertilizer, or watering systems in agricultural operations.

### 2. Background

Various herbicides are used to kill weeds that can prevent proper growth and development of a desired crop plant. Crops also may be fertilized using a water-based fertilizers. In areas of the world where rainfall is insufficient, irrigation systems have been devised to deliver water to a crop so it can complete its growth and harvest cycle.

### SUMMARY

Implementations of a data acquisition unit for a ground vehicle may include an enclosure; a single board computer included in the enclosure; and a base board; operatively coupled with the single board computer. The data acquisition unit may include an optocoupler operatively coupled with the single board computer; at least one chlorophyll fluorescence sensor coupled with the optocoupler; at least one camera coupled to the base board; and a global positioning sensor coupled with the base board. The data acquisition unit may include a flow meter coupled with the single board computer; and a power source operatively coupled with the single board computer and with the base board.

Implementations of a data acquisition unit may include one, all, or any of the following:

The wireless access point may be coupled with the single board computer data acquisition unit may include a central control unit coupled with the single board computer.

The enclosure may be configured to attach to an herbicide sprayer.

The chlorophyll fluorescence sensor may be configured to attach to a boom of the herbicide sprayer; the at least one camera may be configured to attach to the boom adjacent to the chlorophyll fluorescence sensor; and the flow meter may be configured to couple into an herbicide feed line of the herbicide sprayer.

Implementations of a central control unit for a ground vehicle may include an enclosure; a single board computer included in the enclosure; a switch including at least one power over ethernet port; and at least one chlorophyll fluorescence sensor coupled with the single board computer. The central control unit may include at least one camera coupled to the power over ethernet port; a global positioning sensor coupled with the single board computer; a flow meter coupled with the single board computer; and a battery operatively coupled with the single board computer and with the switch.

Implementations of a central control unit may include one, all, or any of the following:

The central control unit may include a battery charger, a battery protection circuit, a step up regulator, two or more breakers, and a transformer.

The central control unit may include a wire coupled to an ignition wire of the ground vehicle.

The switch further may include a wireless access point.

The enclosure may be configured to attach to an herbicide sprayer; the chlorophyll fluorescence sensor may be configured to attach to a spray boom of the herbicide sprayer; the at least one camera may be configured to attach to the boom adjacent to the chlorophyll fluorescence sensor; and the flow meter may be configured to couple into an herbicide feed line of the herbicide sprayer.

Implementations of a method of spot spray operation may include while using an herbicide sprayer with a data acquisition unit or central control unit coupled thereto while the herbicide sprayer is traversing a geographic area: using a single board computer included in the data acquisition unit and sending a trigger signal to a camera coupled to the herbicide sprayer. The method may include receiving an image from a field of view of the camera; with the image, prompting an artificial intelligence model operatively coupled with the single board computer to determine a type of one or more objects in the image; and receiving a recommendation from the artificial intelligence model of the type of the one or more objects in the image. If the type is a gopher hole or standing water, determining a global positioning coordinate associated with a location of the data acquisition unit or central control unit at a time of sending of the trigger signal and storing the image and the global positioning coordinate in a memory operatively coupled with the single board computer. If the type is a weed, determining a global positioning coordinate associated with the location of the camera and storing the image and the global positioning coordinate in the memory operatively coupled with the single board computer; and sending the image to a cloud computing system.

Implementations of a method of spot spray operation may include one, all, or any of the following:

Sending the trigger signal to the camera further may include sending the trigger signal at a time interval determined by a calculated speed of the herbicide sprayer.

The calculated speed may be determined using global positioning coordinates from a global positioning sensor included in the data acquisition unit or central control unit which may be operatively coupled with the single board computer.

The method may include receiving a weed detection signal from a chlorophyll fluorescence sensor; sending a weed trigger signal to the camera; receiving a weed image from the field of view of the camera in response to the weed trigger signal; and storing the weed image in the memory operatively coupled with the single board computer. The method may include determining a global positioning system coordinate of the data acquisition unit or central control unit at a time of sending the weed trigger signal and storing the global positioning system coordinate in the memory; and sending the weed image and the global positioning coordinate to a cloud computing system.

The method may include using a portable computing device in communication with the data acquisition unit or central control unit and with the cloud computing system: generating a computer interface showing the location of the weed image in the geographic area; and receiving from a user a selection of a location of the weed image. The method may include generating a computer interface including the weed image; receiving from the user a selection requesting analysis of the weed image to identify a weed type of a weed in the weed image; and transmitting an analysis request to the cloud computing system to prompt an artificial intelligence model operatively coupled with the cloud computing system to determine a type of one or more weeds in the weed image. The method may include receiving a recommendation from the artificial intelligence model of the type of the one or more weeds in the weed image; and generating a computer interface including the weed image and the recommendation.

The method may include, if the type is one of a gopher hole or standing water, using a portable computing device in communication with the data acquisition unit and with the cloud computing system and generating a computer interface showing a location of the image in the geographic area. The method may include receiving from a user a selection of the location of the image; generating a computer interface including the image including a queuing element; in response to a user selecting the queuing element, sending a message to one or more persons or to one or more autonomous vehicles to queue an action on the gopher hole or standing water.

The method may include calculating a speed of the herbicide sprayer using global positioning coordinate data from a global positioning sensor included in the data acquisition unit or central control unit which may be operatively coupled with the single board computer; and with a nozzle flow rate from each nozzle, the speed, and a total width of a spray boom of the herbicide sprayer, calculating a broadcast application rate of the herbicide sprayer. The method may include, with the broadcast application rate of the herbicide sprayer and a total area sprayed during a run, calculating a theoretical total applied gallons of herbicide; with a flowmeter, measuring an actual total dispensed gallons of herbicide over the total area sprayed during the run; and calculating a percentage of herbicide saved during the run using the theoretical total applied gallons of herbicide and the actual total dispensed gallons of herbicide.

The method may include, using a portable computing device in communication with the data acquisition unit and with the cloud computing system: generating a computer interface including the percentage of herbicide saved during the run.

Prompting the artificial intelligence model further may include prompting using the single board computer.

Prompting the artificial intelligence model may include prompting using the cloud computing system.

he foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a perspective view of an implementation of an herbicide sprayer/spot spraying system;

FIG. 2 is a perspective view of an implementation of a spray boom;

FIG. 3 is a perspective view of an implementation of a spray tank;

FIG. 4 is a perspective view of an implementations of a data acquisition unit;

FIG. 5 is a top view of the data acquisition unit of FIG. 4;

FIG. 6 is a perspective view of an implementation of a portable computing device;

FIG. 7 is a perspective view of an implementation of an herbicide sprayer/spot spraying system;

FIG. 8A is a front view of an implementation of an autonomous spot spraying system;

FIG. 8B is a side view of the autonomous spot spraying system of FIG. 8A;

FIG. 8C is a bottom view of the autonomous spot spraying system of FIG. 8A;

FIG. 9A is a perspective view of an implementation of a spot spraying system;

FIG. 9B is a rear view of an implementation of a spot spraying system during operation;

FIG. 10 is a diagram of an implementation of a sensing system;

FIG. 11 is a diagram of another implementation of a sensing system;

FIG. 12 is a perspective view of an implementation of a data acquisition unit;

FIG. 13 is a top view of an implementation of a data acquisition unit;

FIG. 14 is a top view of an implementation of a data acquisition unit with wiring adjusted to show internal structure;

FIG. 15 is a top view of the data acquisition unit implementation of FIG. 15 with writing routed;

FIG. 16 is a perspective view of an implementation of a central control unit with a cover open;

FIG. 17 is another perspective view of the central control unit implementation of FIG. 17;

FIG. 18 is a schematic of the wiring of an implementation of a central control unit;

FIG. 19 illustrates an implementation of a main user interface;

FIG. 20 illustrates an implementation of a spray user interface;

FIG. 21 illustrates an implementation of a run review interface;

FIG. 22 illustrates an implementation of a live run interface;

FIG. 23 illustrates another implementation of a live run interface;

FIG. 24 illustrates another implementation of a live run interface;

FIG. 25 illustrates an implementation of a weed analysis interface;

FIG. 26 illustrates the weed analysis interface of FIG. 26 following analysis of a weed type;

FIG. 27 illustrates a reporting interface implementation;

FIG. 28 illustrates another implementation of a reporting interface;

FIG. 29 illustrates an implementation of a signing interface for a portable computing device;

FIG. 30 illustrates an implementation of a main user interface for a portable computing device;

FIG. 31 illustrates an implementation of a spray interface;

FIG. 32 illustrates an implementation of a live run interface;

FIG. 33 illustrates an implementation of a farm management interface;

FIG. 34 illustrates an implementation of a weed reporting interface;

FIG. 35 illustrates an implementation of a weed information interface;

FIG. 36 illustrates an implementation of an agronomist contact interface;

FIG. 37 illustrates an implementation of a farmer assistant interface;

FIG. 38 illustrates an implementation of an agronomist scheduling interface;

FIG. 39 illustrates an implementation of a news feed interface;

FIG. 40 illustrates an implementation of a computer interface showing response scoring results from an artificial intelligence for various weed images;

FIG. 41 illustrates an implementation of a sprayer management interface;

FIG. 42 illustrates an implementation of a sprayer configuration interface;

FIG. 43 illustrates an implementation of a sprayer configuration interface and an implementation of a queuing interface; and

FIG. 44 illustrates an implementation of a run summary interface with an implementation of a queuing interface.

### DESCRIPTION

This disclosure, its aspects and implementations, are not limited to the specific components, assembly procedures or method elements disclosed herein. Many additional components, assembly procedures and/or method elements known in the art consistent with the intended spraying and scouting systems will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such spraying and scouting systems and implementing components and methods, consistent with the intended operation and methods.

Implementations of herbicide spraying systems/spot spraying systems relate to systems for applying herbicidal chemicals selectively to identified undesired plants (weeds). Implementations of weed identification systems relate to systems for identifying undesired plants (weeds), ordering spraying of weeds, and reporting during and after spraying on chemical application, types of weeds identified, and/or locations of weeks/sprays. While the use of herbicide by the spraying systems disclosed herein is discussed, this is only by way of example, as the principles disclosed herein would apply equally to spraying of fertilizer or application of water in spot fertilizer and/or irrigation systems.

In particular system implementations disclosed herein, vehicle mounted spot spraying systems are disclosed that utilize chlorophyll fluorescence to trigger spraying of a directed stream of herbicide toward a detected weed. These systems utilize chlorophyll fluorescence detected by a sensor to identify the presence of undesired plants (weeds) and then trigger a discharge or spray of herbicide at the same time or specified time thereafter as a function of vehicle velocity in a field or other area being treated. The goal is to ensure that the spray of herbicide contacts only the weed detected and thus avoids blanket spraying of all plants in a field with herbicide. Blanket spraying often requires specialized crops genetically engineered to be resistant to the herbicide. Blanket spraying also expends a large amount of herbicide, which is generally expensive, to kill only a discrete number of weeds in a field. Finally, blanket spraying techniques or systems that only use chlorophyll fluorescence sensors to detect weeds do not provide any telemetry or image information that could be used to determine weed type or assess the equipment performance or equipment problems the vehicle mounted spot spraying systems may be experiencing during or after a run through a field.

While the disclosure herein has focused on systems that include chlorophyll fluorescence, some system implementations may not include chlorophyll fluorescence sensors, but may rely on camera imaging using various methods disclosed herein to identify and then target weed with herbicide sprays. Some system implementations may not be engaged in spraying anything, but may be primarily directed to perform visual scouting of a field or other agricultural area to identify any of a wide variety of issues on or near the ground such as, by non-limiting example, gopher holes, standing water from leaks, leaking watering equipment, leaking pipes, insect counts, holes in the earth, downed branches, crop spacing, stage of crop development, crop damage, fruit condition, blossom density, weed types, or any other desired issue or item that can be detected from a camera image. Such implementations may be primarily a data gathering operation to allow for objective and consistent assessment of the condition of a crop, field, or location on an agricultural facility. The various system implementations disclosed herein may be used and otherwise modified to allow for all of these types of operations using a ground vehicle.

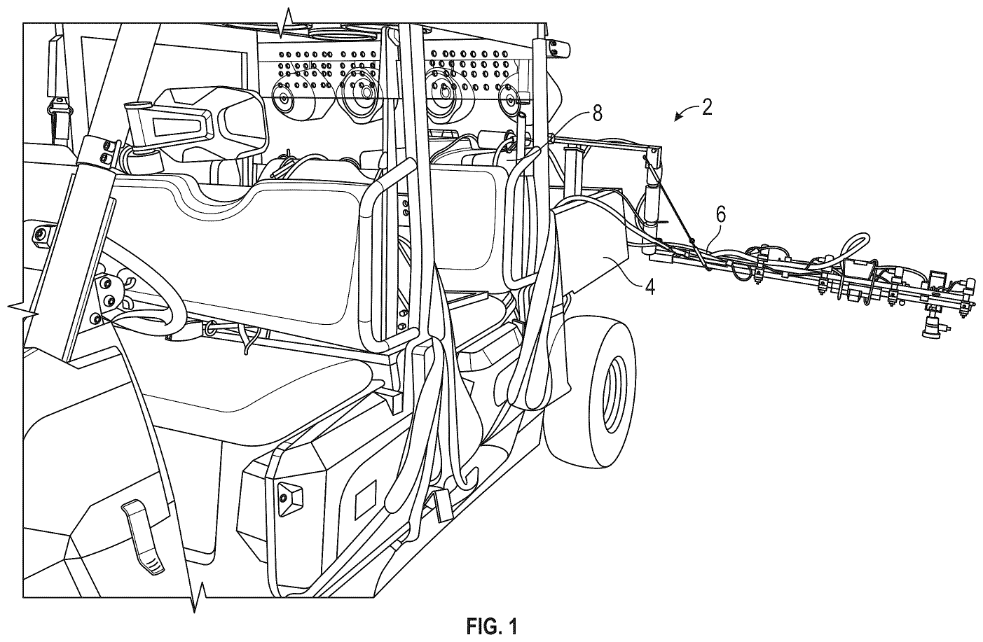

Referring to FIG. 1, an implementation of a spot spraying vehicle 2 is illustrated. Here the vehicle 2 is a four wheeled side by side that includes a bed 4 that has two booms 6 mounted thereto on each side. While the use of a side by side is illustrated in FIG. 1, a wide variety of vehicle types could be utilized in implementations of spot spraying vehicles, including, by non-limiting example, tractors, trailers, boom spraying trailers, trucks, utility task vehicles (UTVs), all-terrain vehicles (ATVs), spraying attachments to a tractor or other vehicle, or any other vehicle type adapted to enter and traverse a geographic area in which spot spraying/data gathering is desired to be performed. A tank 8 that holds herbicide is also mounted in the bed.

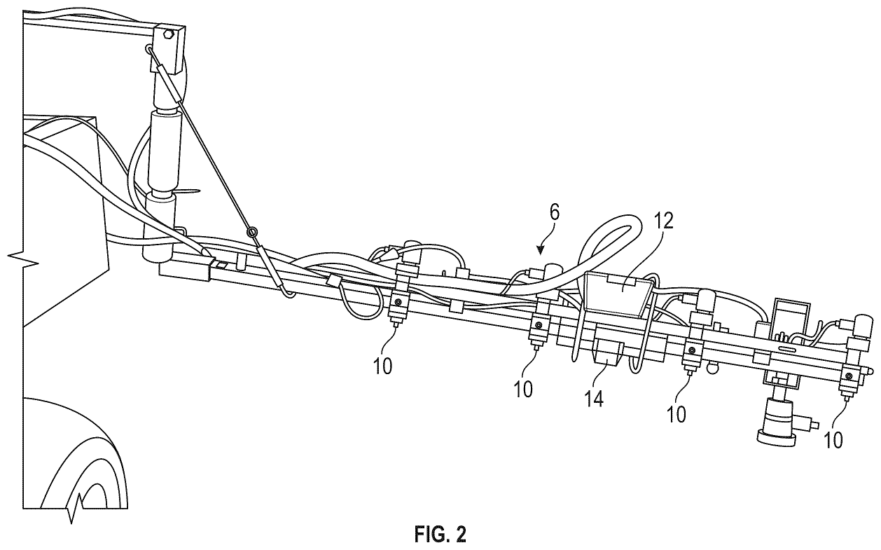

Referring to FIG. 2, an enlarged view of one of the booms 6 of the implementation of FIG. 1 is illustrated that shows four spray nozzles 10 spaced along a length of the boom 6 along with a chlorophyll fluorescence sensor 12 coupled thereto. Below the chlorophyll fluorescence sensor 12, a camera 14 is coupled in line/aligned with the sensor. While the use of four spray nozzles 10 directed downwardly is illustrated in FIG. 1, more or fewer than four spray nozzles could be utilized in various implementations, and they could be directed at any angle from the position from the boom or perpendicularly to the boom depending on the desired spray pattern/growth pattern of the vegetation being treated. The physical alignment of the camera 14 and chlorophyll fluorescence sensor 12 is intentional, as it allows the camera's field of view to be aligned with and substantially similar to that of the chlorophyll fluorescence sensor 12. This allows the camera 14 to capture an image using visible light (or another desired light wavelength) of what the chlorophyll fluorescence sensor 12 is seeing at substantially the same time the sensor is used to detect a weed.

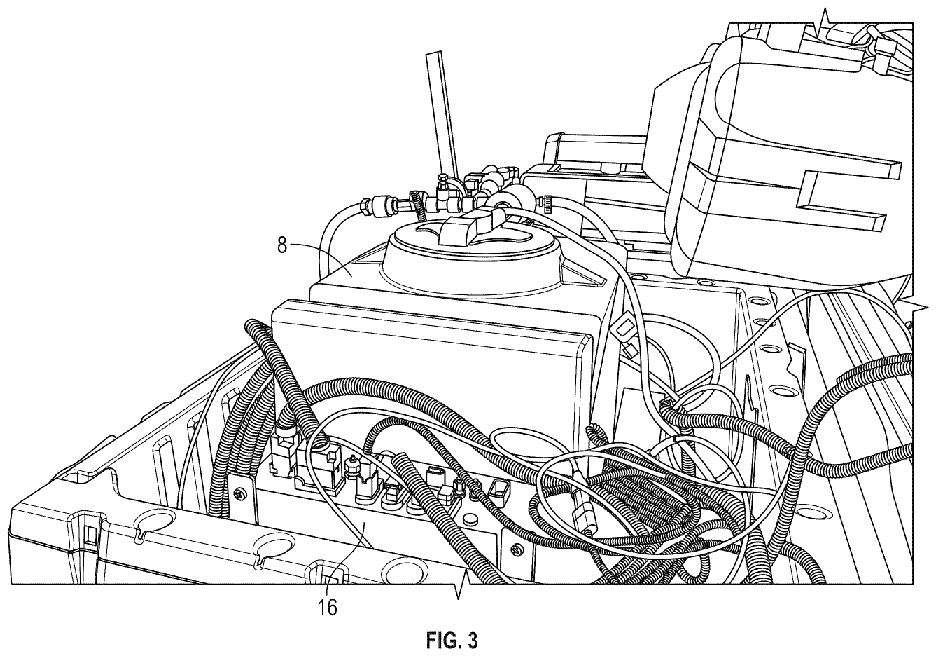

Referring to FIG. 3, an implementation of a tank/spray tank 8 is illustrated that during operation is filled with a mixture of herbicide and water and contains a fluid connection to the various spray nozzles 10. Also illustrated in FIG. 3 is the spray controller 16 that receives a notification from the chlorophyll fluorescence sensor 12 that a weed has been detected and then times/aims the spray from one or more of the spray nozzles 10 toward the detected weed. In various implementations, the spray controller 16 sends electrical signals to one or more solenoid activated valves that are included in each of the spray nozzles 10 to begin and end the period of spray. In various implementations, the spray may be enabled by pressurizing the contents of the tank 8 using compressed air or using a pump, or a pressuring pump is in fluid connect with the tank 8 that pressurizes the fluid from the tank 8 on its way to the spray nozzles 10.

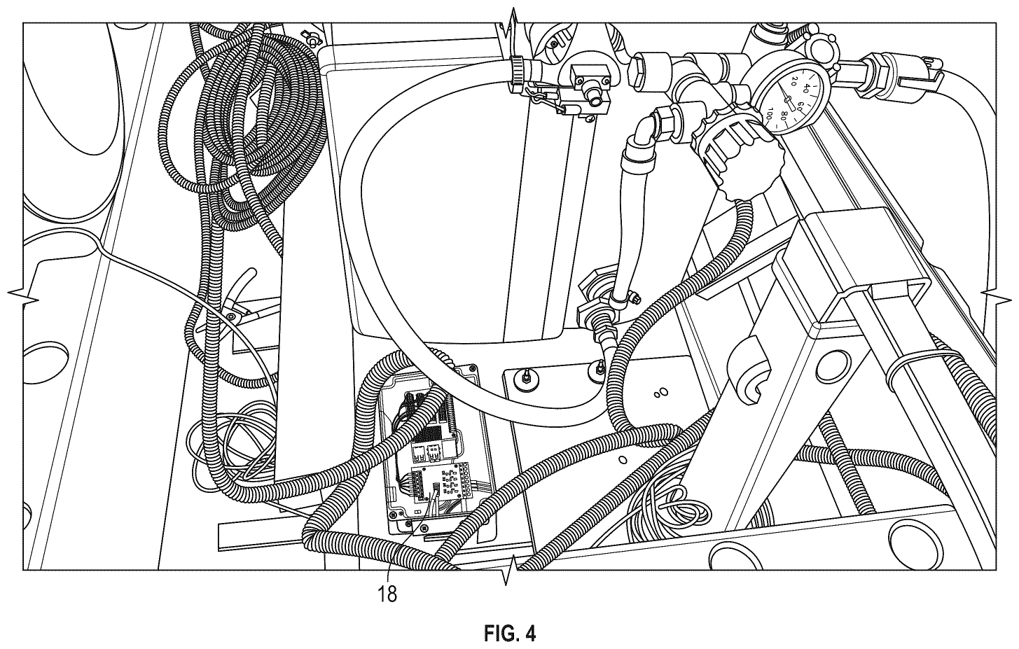

Referring to FIG. 4, adjacent to the tank 8 is an implementation of a data acquisition unit 18 that is in electrical connection with the camera 14. In some implementations, the data acquisition unit 18 is also in communication with the chlorophyll fluorescence sensor 12 and/or the spray controller 16 which allows the data acquisition unit 18 to receive a signal when the chlorophyll fluorescence sensor 12 has detected a weed. In other implementations, the data acquisition unit 18 may be in electrical connection only with the camera 14.

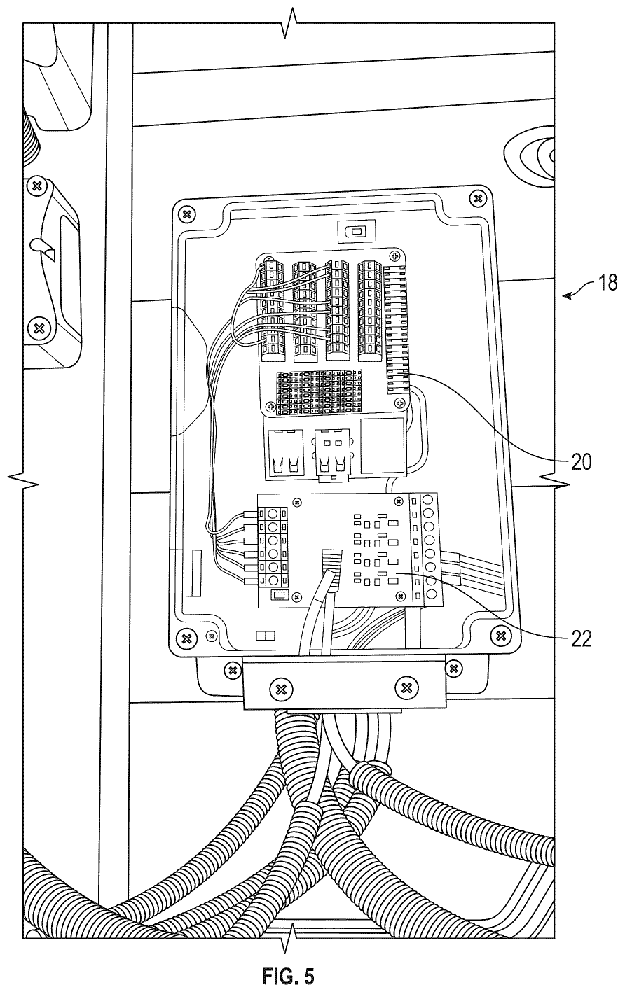

Referring to FIG. 5, a detail view of the data acquisition unit 18 of FIG. 4 is illustrated. As illustrated, the data acquisition unit 18 includes power components 20 that ensure the unit has the power to supply to the camera 14 and operate the rest of the components. In the particular implementation of the data acquisition unit 18 illustrated in FIG. 5, a controller 22 is included that in this case is a small single board computer marketed under the tradename RASPBERRY PI 4 by the Raspberry Pi Foundation of the United Kingdom. While the use of such small single board computers is disclosed in this document, any of a wide variety of controller types could be utilized for the data acquisition module, including, by non-limiting example, microcontrollers, field programmable gate arrays, application specific integrated circuits (ASICs), microprocessors, or other small single board computer types or controller circuit types.

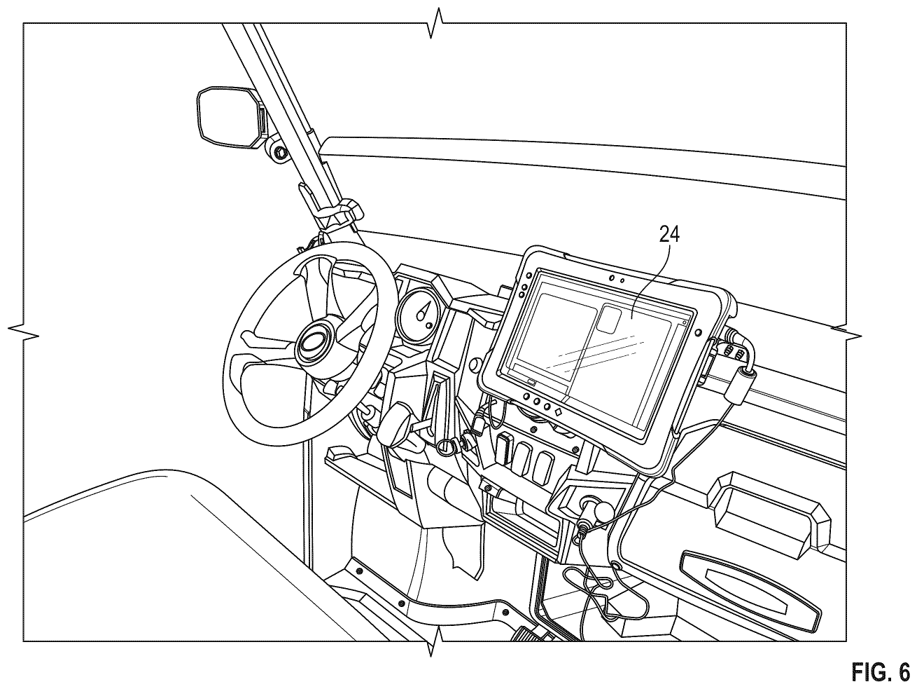

Referring to FIG. 6, whether via a wired connection or wireless connection, the data acquisition unit 18 is connected to a display/portable computing device 24. Either through a wireless module in the data acquisition unit 18 itself and/or through the portable computing device 24, data from the data acquisition unit 18 can be transmitted to a computing system/cloud computing system over a wireless telecommunication network, like a cellular telecommunication network or wireless internet telecommunication network. In some implementations, where cellular (4G LTE, 5G, etc.) or wireless internet (WiFi, etc.) signal is inadequate or not present for the data transfer, the data acquisition unit 18 may store the data onboard until the spot spraying system 2 returns to a location on the agricultural facility where adequate cellular or wireless internet connectivity for data transfer exists. The data may then be transferred to a local computing system on the premises of the agricultural facility prior to be transmitted to a cloud computing system in various implementations. In such implementations, the ability to utilize on-premises computing systems to handle the data transfer may reduce the risk of partial data transfers from the data acquisition unit 18 by relying on more powerful computing resources and/or better internet connectivity to handle the data transfer.

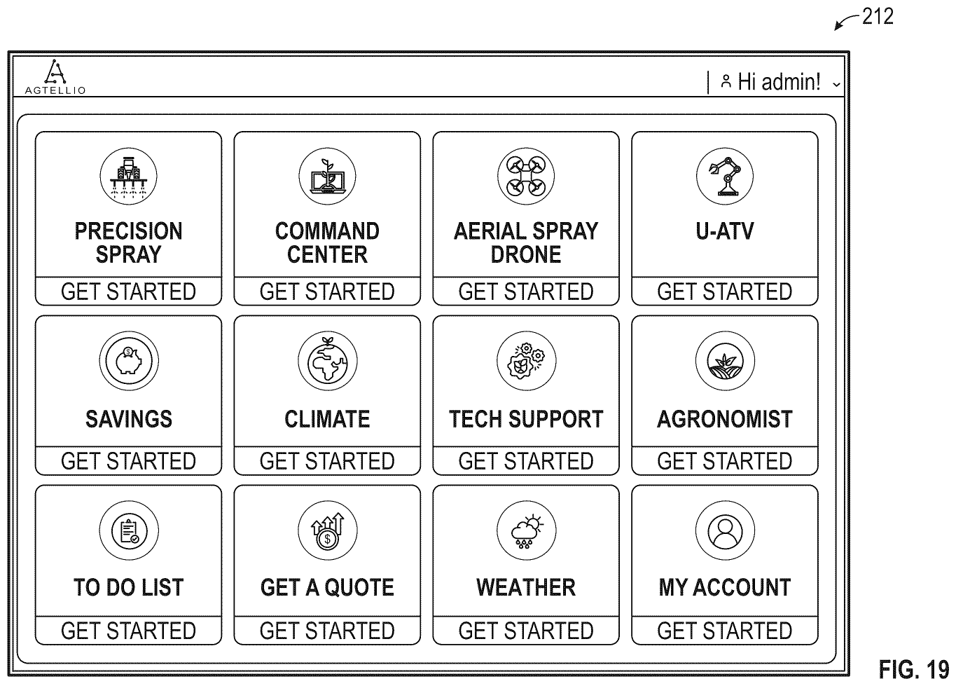

As illustrated in FIG. 19, the portable computing device 24 may include a main computing interface that the user utilizes when beginning/ending a spraying run and when sending/analyzing data from the data acquisition unit. In various method implementations, the portable computing device 24 may enable display image data of identified weeds from the camera and can be used by the user to generate an identification of those weeds using a connection to a trained artificial intelligence system operated on a computing system (like a cloud computing system in various implementations) as described herein.

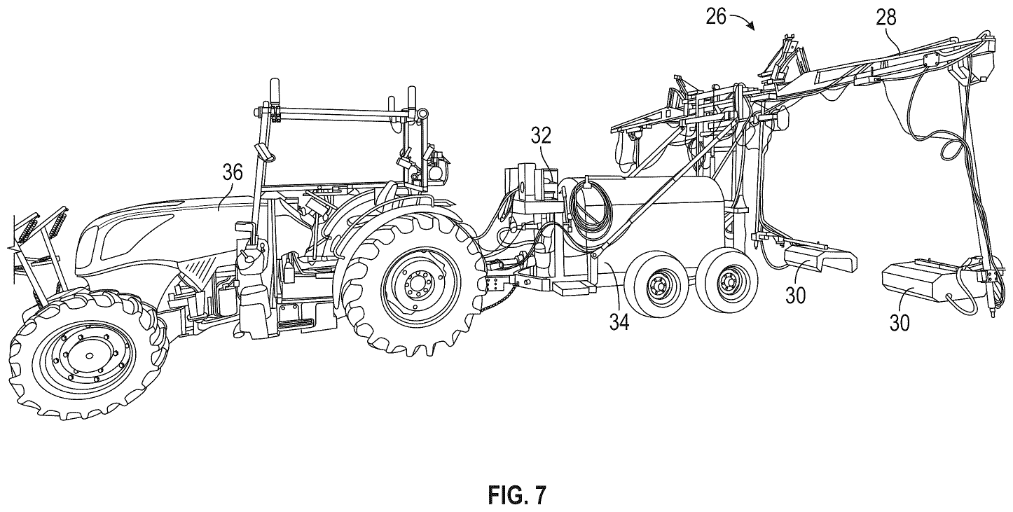

A wide variety of operational configurations for the various spot spray vehicle systems can be devised using the principles disclosed herein. For example, referring to FIG. 7, and implementation of a spot spraying system 26 that is mounted to a raised boom system 28 adapted for spraying around grape vines is illustrated. Here, the camera systems are incorporated into the structure of the lower spraying units 30 and concealed within the canopy of the spraying units 30. Here the raised boom system 26 is part of a trailer 32 that contains the herbicide containing tank 34. The trailer 32 in this implementation is being pulled by an autonomously controlled tractor 36 which has been modified to allow for operation and routing independent of manual human control. In such an implementation, in various method implementations, the tractor and trailer can be assigned using a portable computing device associated with a user and then directed to autonomously travel to a field or other geographic location to begin a spraying run without involving any hands-on manual control or direction. As will be described hereafter, this ability to queue and track spraying progress independent of human intervention/direct human supervision can reduce the number of workers needed to maintain a farm while maintaining the cost/environmental advantages of spot spraying while additionally adding the weed and crop data acquisition capabilities that will be described hereafter.

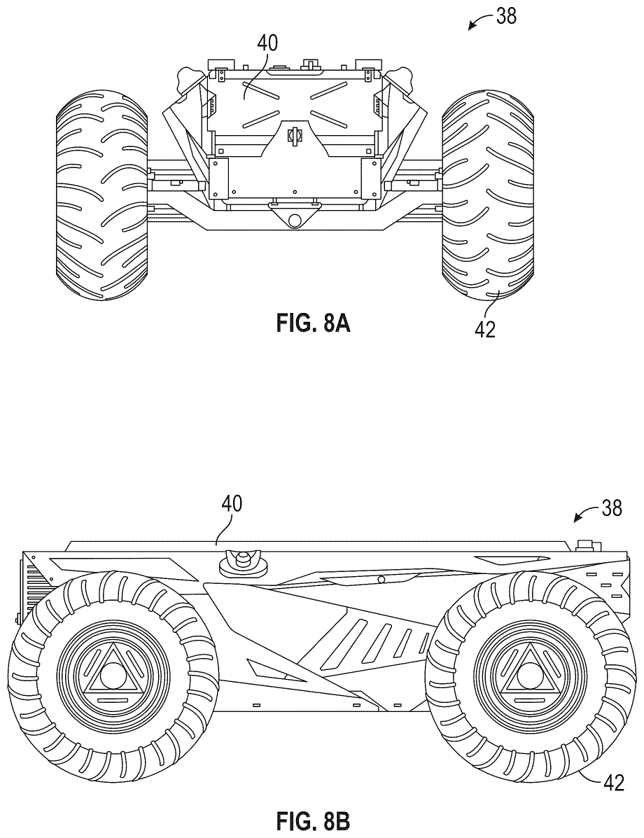

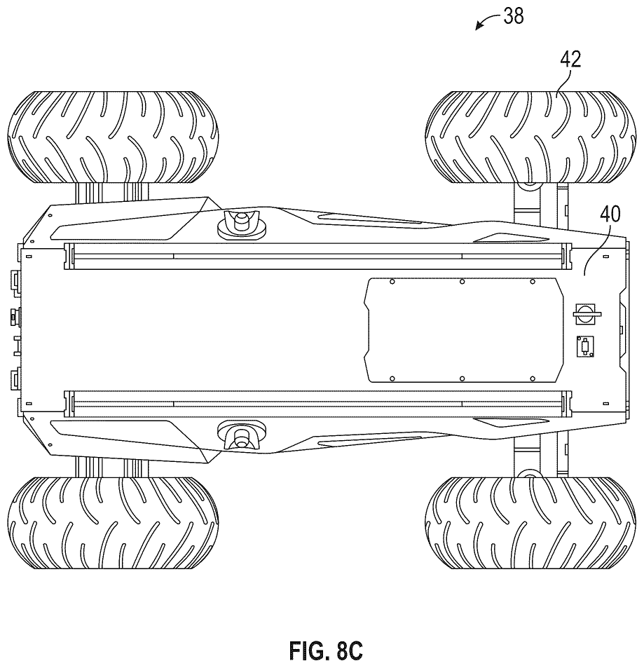

Referring to FIGS. 8A-C, another implementation of an autonomous spot spraying system 38 is illustrated. This implementation is designed to not include a location for a human driver and so the space is dedicated to an integrated tank 40 centered on all terrain wheels 42 to allow the unit to have good mobility in a variety of agricultural environments. This particular implementation may be powered by one or more electric motors or by an internal combustion engine integrated into the vehicle. The profile of the autonomous spot spraying system 38 allows for the affixing of a wide variety of boom systems that have various configurations thereto to allow for spraying of a wide variety of crops. For example, the grape configuration illustrated in FIG. 7 could be affixed thereto as could wide dual boom systems raised a desired height above the crops. In various implementations, the autonomous spot spraying system 38 may have wheels with much larger hubs than those illustrated to raise the vehicle up so it can pass over rows of crops during spraying operations.

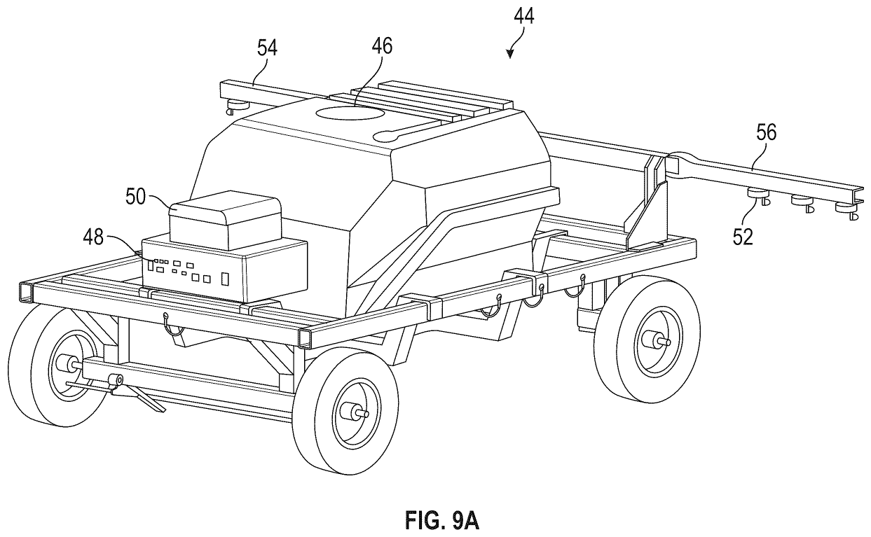

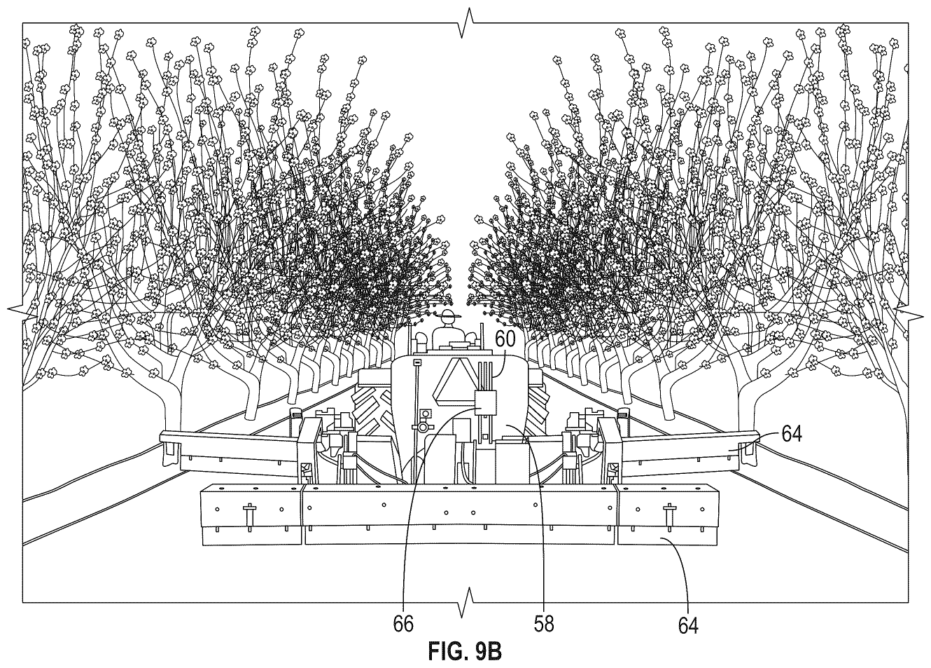

FIG. 9A illustrates another implementation of an autonomous spot spraying system 44. This implementation may be adapted for use in situations with plants that are shorter so the wheels and frame can traverse the rows of plants during operations. As illustrated, an integrated tank 46 is included the operates with a spray controller 48 in combination with a central control unit 50 to gather data using any of the methods and systems disclosed herein. Spray is accomplished using nozzles 52 distributed along booms 54, 56. This system 44 may also be powered using electric motors or using an internal combustion engine in various implementations.

Referring to FIG. 9B, in various implementations, the spot spraying systems may take the form of an attachment to a tractor or other powered farm implementation. Here the spot spraying system 58 is attached to tractor 60 which in this case is being controlled manually by a user. The spray nozzles and cameras in this implementation are located under the shrouds 64 to help prevent any overspray of herbicide from reaching the foliage of the surrounding trees and/or help improve image capture and detection by the chlorophyll fluorescence sensors and/or cameras. In this implementation, the wireless access point 66 is visible which works to transfer data from the system as it traverses among the trees. This implementation shows the wide variety of boom and other configurations that are possible using the principles disclosed herein for various spot spraying systems. Any of the additional configurations and methods of operation in the '099 Provisional previously incorporated herein by references may employed in various system and method implementations.

A wide variety of components and configurations can be used in various data acquisition unit implementations. In FIG. 8 of the '803 Provisional previously incorporated by reference, an implementation of a data acquisition unit is illustrated that includes a small single board computer (RASPBERRY PI branded controller) included in case that includes various headers that connect to the small single board computer that permit various electrical connections to be made thereto. As illustrated in FIG. 9 of the '803 Provisional, the data acquisition unit includes a four channel optocoupler photoelectric isolator module level voltage converter which helps ensure a reliable power source to the components of the data acquisition unit including the case. Included in this implementation is a camera marketed under the tradename ARDUCAM by Arducam Technology Co., Limited of Kowloon, Hong Kong. This particular camera illustrated in FIG. 8 of the '803 Provisional is designed to connect via a ribbon cable connection to the case and so would be designed for use when the data acquisition unit itself is mounted out on the boom (rather than on the vehicle/trailer itself. In other data acquisition units, the camera may be a camera marketed under the tradename ARDUCAM 1080P IMX291 by Arducam Technology Co., Limited and connected to the data acquisition unit via a universal serial bus (USB) connection which allows the camera to be mounted out along the boom itself away from the data acquisition unit. Also, in various data acquisition units various global positioning sensor (GPS) sensor modules may be included to allow the data acquisition unit to store GPS coordinates of the data acquisition unit along with images as they are taken by the camera.

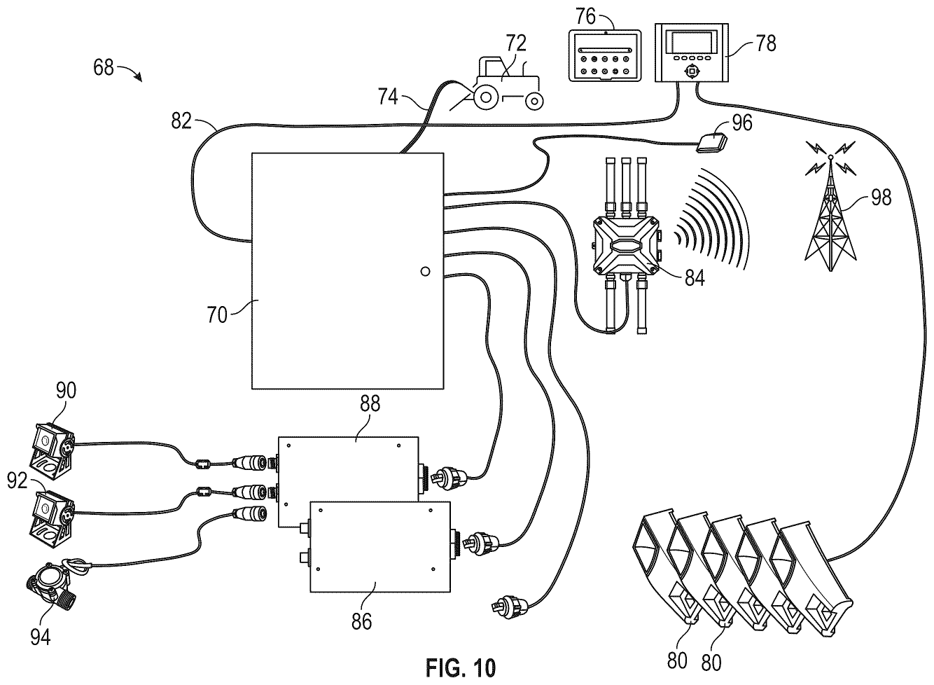

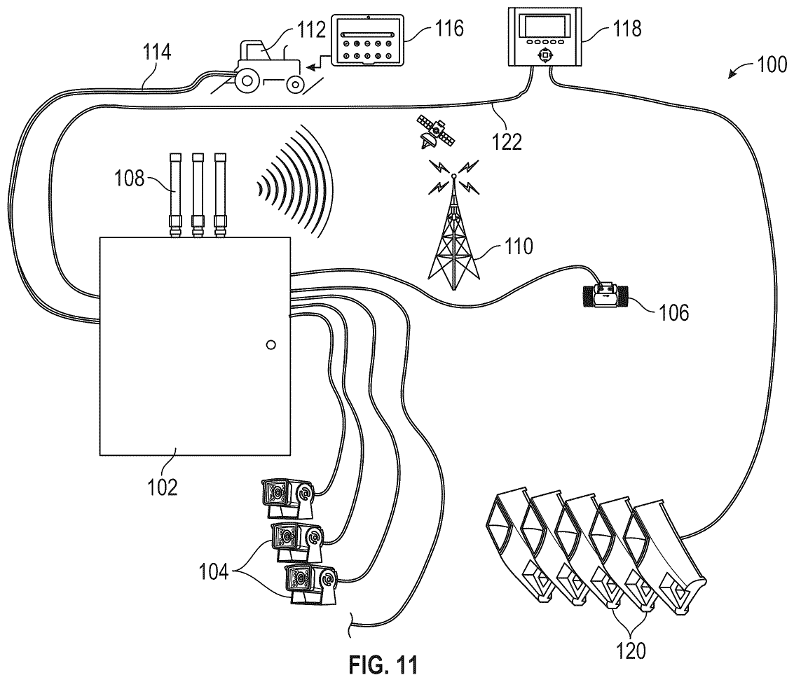

As illustrated in FIG. 10 of the '803 Provisional, this data acquisition unit implementation is mounted to a support bracket/breadboard that also includes various routed electrical connections on a rear surface of the board. Referring to FIG. 11 of the '803 Provisional, following assembly of the various components, the data acquisition unit is then connected to power through openings is a waterproof junction box that prevents water exposure to the data acquisition unit. In this implementation, because the cover of the waterproof junction box is optically transmissive, the camera can take images through the cover if desired.

The various spot spraying systems disclosed herein may use various implementations of sensing systems to allow for both data acquisition and data processing/transfer from the spot spraying vehicle. Referring to FIG. 10, a diagram of a implementation of a sensing system 68 is illustrated. In this implementation, a central control unit 70 is illustrated that receives power and an ignition signal from ground vehicle 72 via wires 74. Various controls for the sensing system and data review can be conducted using portable computing device 76 that is associated with the ground vehicle 72. In this implementation console 78 is also included in the system 68 which is directly coupled via wires to chlorophyll fluorescence sensors 80 and helps with control and interfacing with the sensors 80. The console 78 may receive power from the central control unit 70 and the central control unit 70 receives data from the console 78 via wire 82. In this implementation, an unmanaged switch is included in the central control unit 70 that has various power over ethernet (POE) ports that are used to power wireless access point 84 and data acquisition units 86, 88 to which universal serial bus (USB) cameras 90, 92 are connected along with USB flow meter 94. In this implementation a global positioning sensor 96 is included which in this implementation is coupled to the central control unit 70, but in others may be included in the data acquisition units 86, 88. The wireless access point 84 transmits data over cellular and/or WiFi and/or other wireless telecommunications protocols to a corresponding wireless data reception location 98 which may be on-premises as part of a local area network or off-premises as part of a cellular phone network or wireless broadband internet connection in various implementations. In this implementation, because of the use of the data acquisition units 86, 88, the use of USB, serial, and other devices that utilize other wired communication protocols can be accommodated and enabled while the use of power and signal transfer using ethernet (RJ-45 connectors) is preserved. The use of the unmanaged switch helps reduce the number of custom power cable connections that have to manually made within the data acquisition units 86, 88 and the central control system 70 can help with system reliability and reduce assembly complexity.

While the sensing system 68 of FIG. 10 does allow for the integration of cameras with various connectivity types, additional simplification of the hardware and signal routing is possible. Referring to FIG. 11, another implementation of a sensing system 100 is illustrated that eliminates the data acquisition units of the system of FIG. 10. This implementation can create a significant reduction in components and points of failure in the system as a single central control unit 102 is now suppling all power and receiving all signals directly. To accomplish this, internet protocol capable cameras (IP cameras) 104 that can be powered over ethernet are employed instead of USB cameras. The power to these IP cameras 104 is then supplied by an unmanaged switch included in the central control unit 102. The flow meter 106 is now directly connected with the central control unit 102 which supplies power and receives signal using a USB or other connection as previously described. In various implementations, an unmanaged switch may be utilized, or a wireless access point 108 with POE capability may be utilized which allows the wireless access point to be integrated into the structure of the central control unit 102 itself. As in the previous system, the wireless access point 108 transfers data wirelessly to wireless reception location 110 using cellular or another wireless telecommunication protocol that is either on or off-premises as previously described. The global positioning sensor is also integrated into the central control unit 102.

Power to the central control unit 102 is supplied from the ground vehicle 112 along with an ignition signal wire 114 which allows the central control unit to know when it should begin and stop operation. In the system 100 implementation disclosed in FIG. 11, the central control unit 102 includes a battery power source which allows the system 100 to remain active even when the vehicle 112 is turned off, which can greatly aid in data transfer, particularly where wireless data transfer has to take place at a central location on the agricultural facility due to lack of wireless connectivity in the particular geographic area of operation. A portable computing device 116 may be included which allows for operation of the system 100 remotely or while operating the vehicle 112. A console 118 attached to chlorophyll fluorescence sensors 120 is also coupled via wire 122 to the central control unit 102.

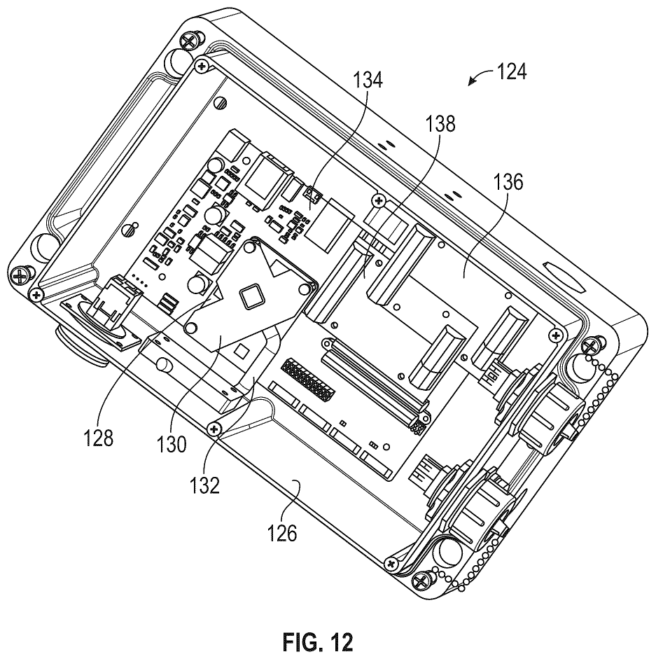

For those implementations of sensing systems that employ data acquisition units, various implementations are disclosed herein. Referring to FIG. 12, a perspective view of a data acquisition unit 124 with a cover removed to show the internal components is illustrated. This implementation includes enclosure 126 in which single board computer 128 (in this case, a RASPBERRY PI 4) is coupled. While the use of a RASPBERRY PI 4 is illustrated, other single board computers could be used including the single board computing systems marketed under the tradenames JETSON by NVIDIA of Santa Clara, California, including the JETSON AGX ORIN, JETSON ORIN NX, JETSON ORIN NANO, JETSON AGX XAVIER, JETSON XAVIER NX, JETSON TX2, and JETSON NANO. In some implementations, the single board microprocessors marketed under the tradename ARDUINO by Arduino A G of Monza, Italy.

Mostly concealing the single board computer 128 from view is heat spreader 130 that includes heat pipe/sink 132 that is fastened to the sidewall of the enclosure 126. In this implementation, the various input/output connections to the single board computer 128 are handled by attaching the single board computer 128 to base board 134. In this implementation, the board is a Waveshare compute module 4 IO Board that has power of ethernet capabilities that is designed to coupled to the RASPBERRY PI 4 using the headers on the RASPBERRY PI 4 and then route various signals and power thereto. Optocouplers/optoisolators 136, 138 are also coupled to the base board 134 which are designed for coupling with the chlorophyll fluorescence sensors. The base board 134 also includes USB ports designed for coupling with at least one camera. A global positioning sensor can also be coupled to the base board as well. Weatherproof connectors in the enclosure allow for a three pin connector to the flow meter, an 8 pin connector to the chlorophyll fluorescence sensors, and RJ45 and USB connections to the other components. A power source is operatively coupled with the data acquisition module 124 which in this implementation comes in through a POE connection through the RJ45 port that provides power to the base board 134 and then to the other system components (see FIG. 10).

The data acquisition unit 124 of FIG. 12 is designed to coupled with a wireless access point through a direct ethernet connection or through connecting to a switch included in a central control unit 70 like that illustrated in FIG. 10. The data acquisition unit 124 is also designed for being fixedly attached to an appropriate location on an herbicide sprayer. The particular location where the data acquisition unit 124 is attached to the herbicide sprayer depends on the design of the sprayer and the location(s) of the cameras and other devices attached to the data acquisition unit 124.

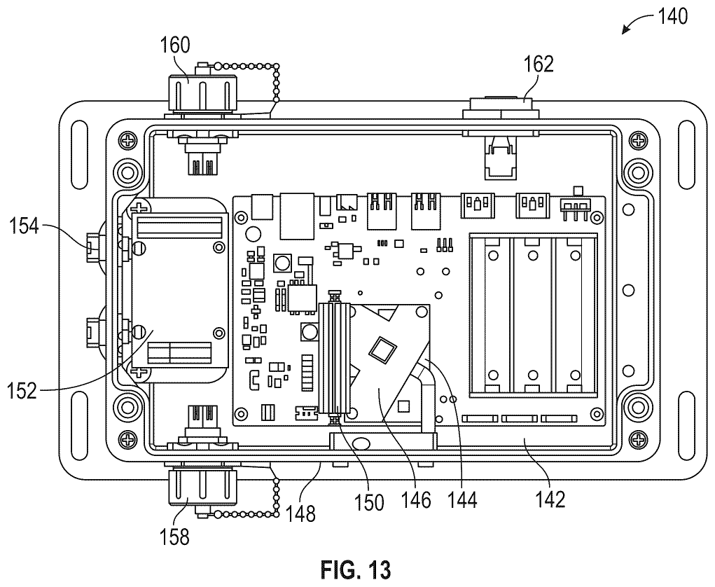

Referring to FIG. 13, another implementation of a data acquisition unit 140 is illustrated. This implementation includes a base board 142 that has a different design than the one in FIG. 12, but which also provides power and input/output support for single board computer 144. Heat spreader and corresponding heat pipe/heatsink 146 is also illustrated attached to the side of enclosure 148. In this implementation, a general purpose input output board (GPIO) is coupled to the single board computer 144. Optocoupler 152 is also attached to the base board 142. In this implementation, 8 pin connector 154 is included using a weatherproof connector for connecting with the chlorophyll fluorescence sensors. Three pin connector 156 is included for connecting with a flow meter. USB bulkhead connectors 158, 160 are used to connect to cameras and/or power. RJ45 connector 162 is used to provide data transfer to a central control unit and, in some implementations, provide power to the data acquisition unit 140.

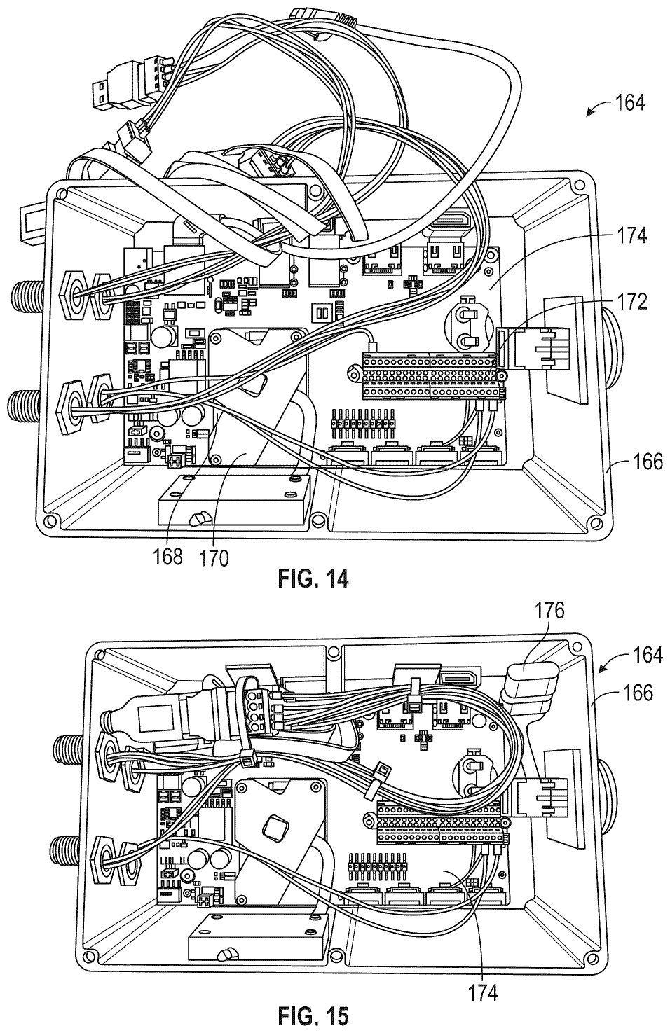

Referring to FIGS. 14 and 15, another implementation of a data acquisition unit 164 is illustrated. Like the other implementations disclosed herein, an enclosure 166 is used to provide weatherproof protection for the components inside. FIG. 14 illustrates the data acquisition unit 164 at a point in assembly where various of the electrical connectors are still disconnected to provide better view of the internal components. In this implementation a single board computer 168 is coupled inside the enclosure 166 with heatsink 170 attached to it. In this implementation, the GPIO portion 172 of the base board 174 is not adjacent the single board computer 168. FIG. 15 illustrates flash drive 176 coupled into a USB port of the base board 174. In various implementations, the flash drive 176 may include computer readable instructions in computer readable media that the single board computer 168 utilizes to operate the data acquisition unit 164. In implementations, the flash drive 176 may be sized to store all of the photos, video, global positioning data, and other data collected by the attached camera(s)/flow meter(s)/chlorophyll fluorescence sensor(s) during a run in the situation where wireless communication with the central control unit is not available during the run. The data can then be transferred from the flash drive 176 when the ground vehicle to which the data acquisition unit 164 returns to a location where wireless communication is then available.

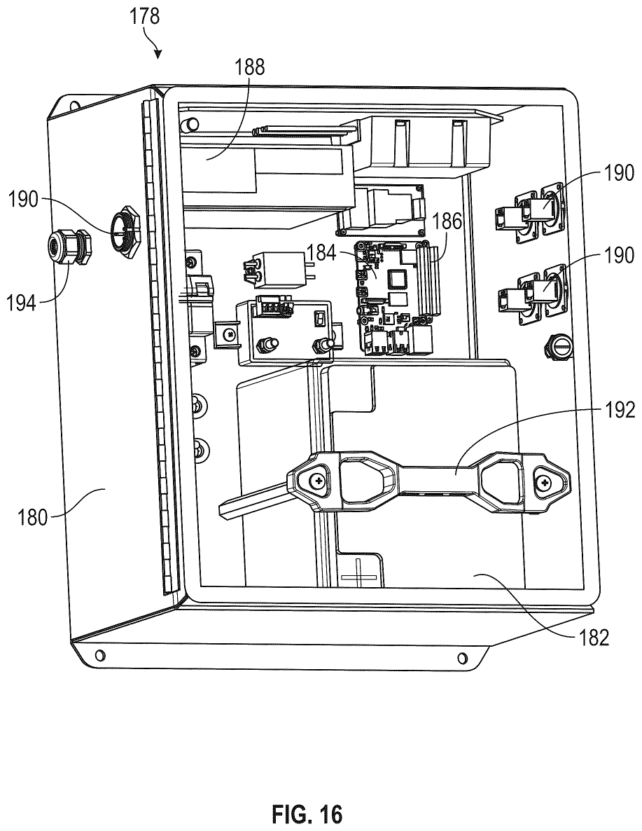

The various sensing system implementations disclosed herein may utilize various central control unit implementations. Referring to FIG. 16, a central control unit 178 configured for use in a sensing system implementation like that illustrated in FIG. 11 is illustrated. In this implementation an enclosure 180 is illustrated with a hinged cover removed to show the components included in the interior. In this implementation, a battery 182 is included that is designed to power the sensing system components even after power from the ground vehicle to which the enclosure 180 is attached to is removed. As previously discussed, this ability to power the central control unit 178 using battery power provides data transfer and process flexibility that relying wholly on vehicle power does not provide. In this implementation, a heat sink has been removed so that the single board computer 184 is better visible along with GPIO connectors 186 coupled thereto. In this implementation, switch 188 is included that contains various POE ports designed to supply power to cameras and other POE devices in the sensing system through weatherproof RJ45 connectors 190 that extend through the sidewall of the enclosure 180. In various implementations, the switch 188 may be coupled to a wireless access point or may include a wireless access point with the associated antennas. Bracket 192 is included to hold battery 182 is in place during operation to prevent vibration from vehicle movement from causing the battery to move inside the enclosure 180. Weatherproof fitting 194 is used to receive a cable from the ground vehicle to which the enclosure 180 is attached. The cable is used to provide power and an ignition signal. The ignition signal is used to indicate to the central control unit that a run is about to begin or that a run has fully ended and may be used in various method implementations to startup/wake up or shut down/sleep various system components

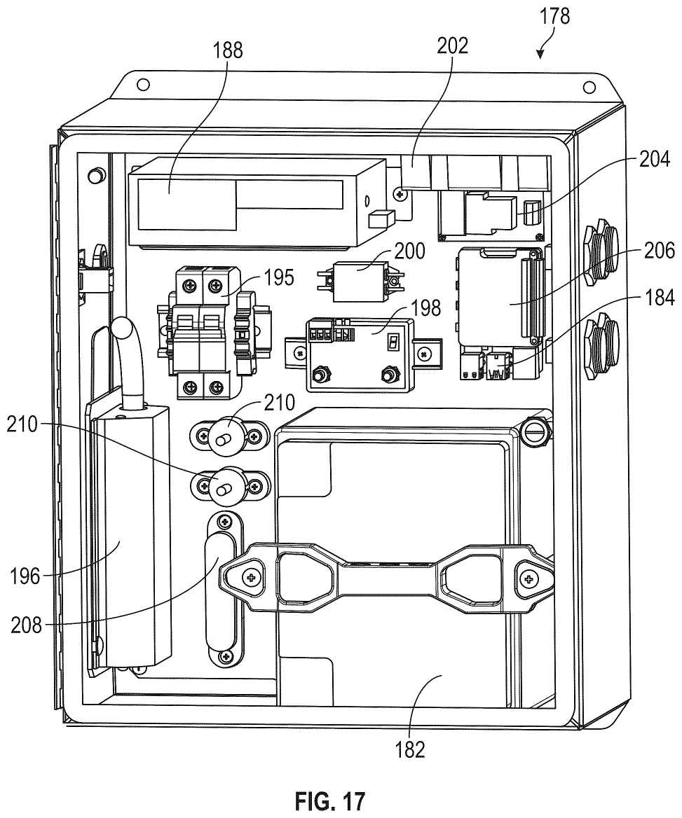

Referring to FIG. 17, another perspective view of the central control unit 178 implementation of FIG. 16 is illustrated. In this view the power handling and control components of the unit that control charging and discharge from the battery 182 are illustrated. Here, battery charger 196 is illustrated operatively coupled to the battery 182 which may be a DC to DC charger in various implementations. A battery protection circuit 198 is also included coupled with the battery 182 and with breakers 195 designed to prevent the central control unit 178 from power surges from the ground vehicle or shorts from the sensing system components and to ensure safe maintenance on the unit. The central control unit 178 also includes transformer 200 and step up regulator 202 adjacent to relay 204. In various implementations, the transformer 200 provides 5 V power to the 5 V signal and computing components of the system like the single board computer 184 (now covered by heat sink 206). The step up regulator in this implementations handles conversion of power between 48 V (which is what the battery may operate at) and 12 V which is what the switch 188 and other system components may use to operate. Additional power transfer components are also included including bus bar 208 and stud terminals 210. The ability to utilize battery power and deliver both power and signal to the other components of the sensing system largely over POE connections adds considerably simplicity to the system and reduces the total number of components that may need to be include.

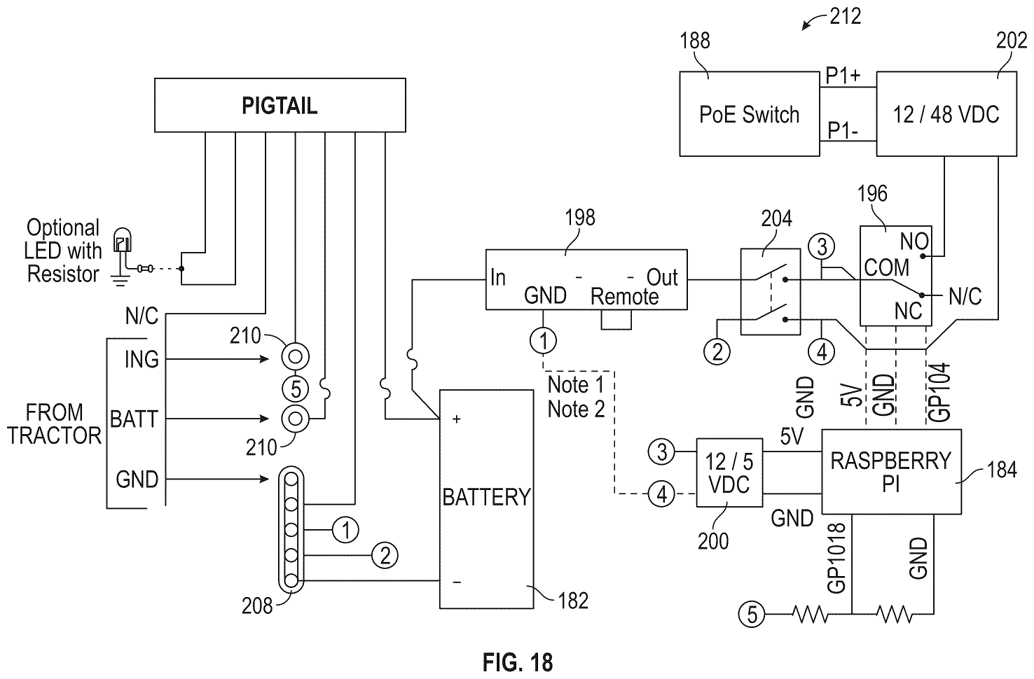

Referring to FIG. 18, a schematic 212 of the power distribution circuits of the central control unit 178 is illustrated. As illustrated, the circuits include battery 182 coupled with the negative terminal to bus bar 208 and on its positive terminal to battery charger 196. Power from the battery of the ground vehicle is brought in on one stud terminal 210 and the ignition signal is brought in on the other stud terminal 210. A pigtail connector is used to bring in and direct the various wiring. Battery protection circuit 198 is illustrated coupled with relay 204 which can be tripped by an output signal from the battery protection circuit 198. Battery charger 196 delivers charging current to the battery 182 through the relay 204 and battery protection circuit 198 and receives 48 V power from the step up regulator 202 which steps up the voltage from the 12 volts supplied by the battery of the ground vehicle in this implementation to 48 V. The switch 188 operates using 12 V, so it receives power from the step up regulator 202 so it can then provide POE power to the various sensing system components. Transformer 200 steps down the 12 V to 5 V for use by the single board computer 184. The schematic 212 implementation of FIG. 18 is merely for the exemplary purposes of this disclosure, and various power distribution systems may be created using the principles disclosed in this document.

The various spot spraying vehicle implementations previously described may be utilized with various systems and methods for queuing/sending/directing/monitoring them to a particular geographic location where spraying is desired. Referring to FIG. 19, a main user interface 212 is illustrated that can be generated on a computing device, which may be a portable computing device, desktop computing device, laptop computing device, or server computing device associated with a user. The user interface may be generated using a web browser, a desktop application, or by an app operating on a desktop, laptop, or portable computing device. As illustrated in FIG. 19, the user interface allows the user to begin the process of starting a particular task related to a farm or other agricultural facility that utilizes equipment, resources, or data collected by equipment operating on the farm or other agricultural facility. To begin queuing/starting a spraying operation, the user would click on or touch a screen on which the “Precision Spray” user interface is displayed.

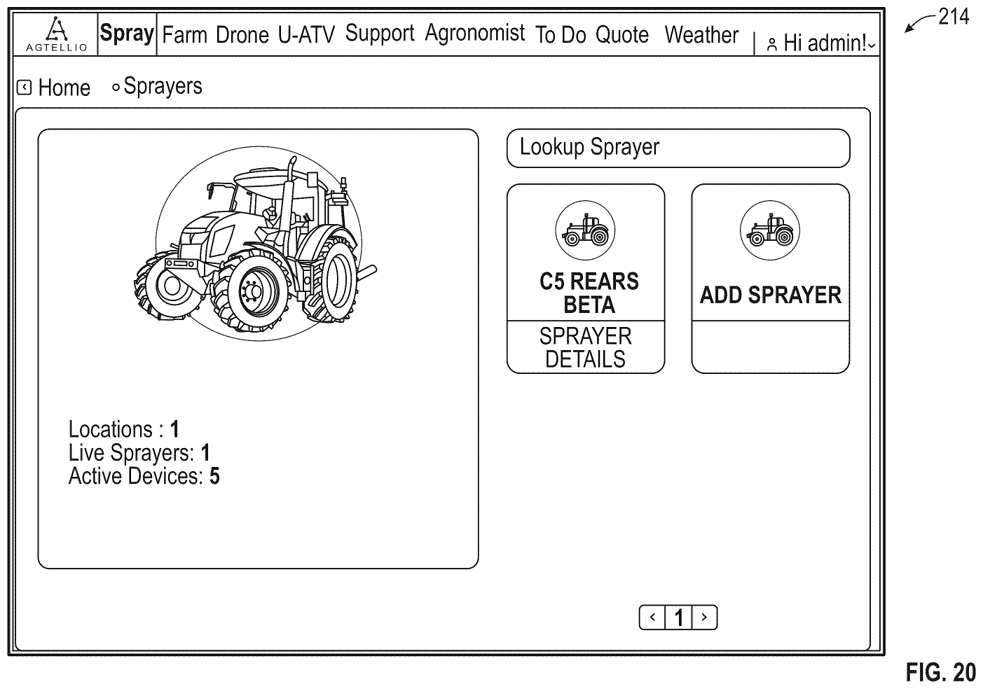

FIG. 20 shows a second user spray interface 214 created by the computing device in response to selecting the “Precision Spray” button/area of the interface of FIG. 19. As part of generating this spray interface 214, the computing device queries a database of available spot spraying vehicles associated with the particular farm/agricultural facility and then displays information regarding each in the second user interface with a corresponding button/tile. The user can then select the button/tile for the desired spot spraying vehicle to view additional details and begin the process of specifying the details needed to send that spot spraying vehicle on a spraying run.

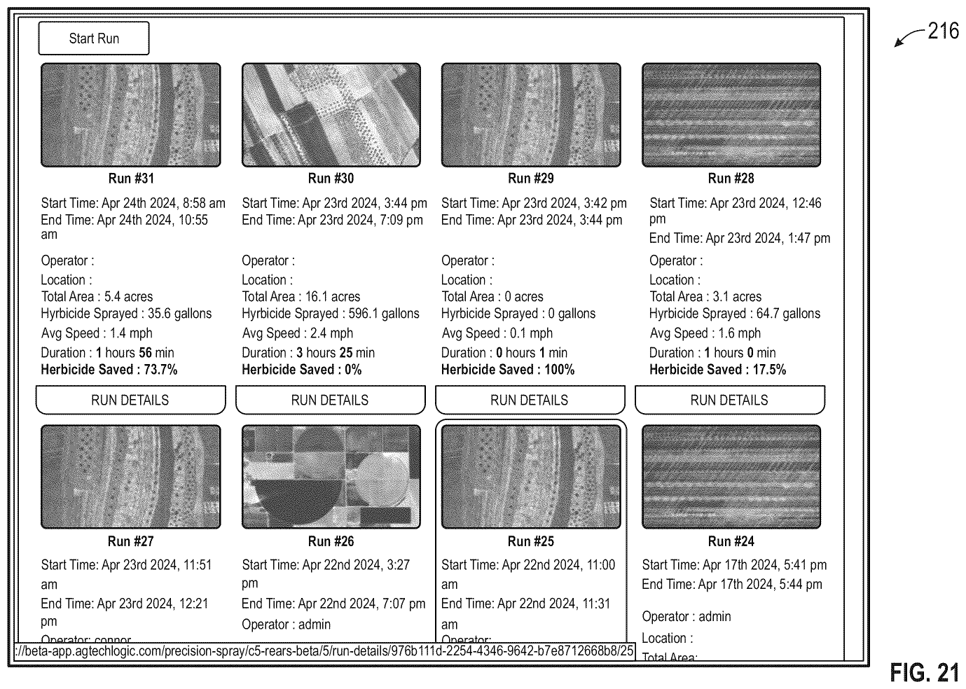

In response to selecting the button/tile for a desired spot spraying vehicle, a third computer interface (run review interface 216) (see FIG. 21) opens that contains a button that the user can select to begin the process of specifying a new run and also contains run tiles that summarize data from previously executed runs performed by the selected spot spraying vehicle or other spot spraying vehicles associated with the farm or other agricultural facility. In some method implementations, the user can select one of the run tiles to initiate the process of sending the selected spot spraying vehicle out to do the same run. In other implementations, the user can copy some or all of the run data associated with the run tile and then paste/transfer that run data to the newly created run. After the run data has been specified, the user can then direct (by clicking a button/tile) the run to execute immediately (on click/selection) or schedule the run to begin at a predetermined day/time. Where the specified spot spraying vehicle is an autonomous vehicle, the ability to schedule/execute the run using the computing system may permit the user to then move on to other tasks while the autonomous vehicle drives out to the specified geographic location for the run and begins the spot spray process. Where the specified spot spraying vehicle is non-autonomous, the user's execution of the run at the start of the spot spraying process occurs after driving the specified spot spraying vehicle to the desired geographic location. At this point, the sensing system starts the process of data collection during spot spraying as the user drives the vehicle.

During the run, the computing device has the ability to query one or more databases that contain data related to the ongoing run and generate various databases that show the progress of the selected spot spraying vehicle during the run. The data displayed is all or a subset of data being collected by the data acquisition unit and/or spray controller during the run that is being transmitted wirelessly over the wireless telecommunication network to a computing system that includes the various databases (like a server system present on the farm/agricultural facility or a cloud computing system). FIG. 22 illustrates a live run computer interface 218 that includes a visual view (satellite image in this case) of the geographic location of the run along with a table of real-time and cumulative data associated with the run along with a location (pin) 220 of the spot spraying vehicle carrying out the run. This particular computer interface is designed to show route data as tracked by GPS coordinates collected by the sensing system of the spot spraying vehicle during the duration of the run up to the time of the generation of the computing interface by the computing device. Here, the spot spraying vehicle is three hours and 25 minutes into a run and is moving at a speed of 2.4 miles per hour and has traversed all of the regions indicated in arrows during the run. The ability to see in real time that the vehicle is moving can help the user to monitor the progress of an autonomous spot spraying device to verify that it is actually operating and has not encountered a difficulty (break down, loss of connectivity) that is preventing it from continuing the run. In particular implementations, the computing system may have various alarm thresholds for one or more of the data values collected for a run and then may send notifications to the user when the thresholds are exceeded by the data (or the data drops below the thresholds). Here, for example, if the speed of the vehicle dropped to zero, then the user could be sent a notification that the autonomous spot spraying vehicle has stopped moving and likely has encountered a problem that needs user intervention, either remotely or directly at the vehicle's location.

Where the spot spraying vehicle is being driven/controlled manually, the live run interface of FIG. 22 helps management/supervisors to observe the progress of the user who is driving the vehicle and associated alerts may allow management/supervisors to determine quickly that a problem with the vehicle has arisen or that the user is taking an unauthorized break/pause in work. This can assist management/supervisors with monitoring user employee activity to ensure that expected work hours are accomplished. The alerts may also help management/supervisors to determine if the user is carrying out the run properly. For example, in order for the spot spraying vehicle to effectively operate, it may need to be driven no faster than a given speed. Thus, when management/supervisors observe via the live run interface 218 of FIG. 22 and/or alerts that the speed of the spot spraying vehicle is exceeding the specified speed, they can take corrective action as they will know the location(s) in the run where the speed was exceeded via the GPS data and where follow up spraying may be needed. They can also take appropriate corrective action with the user regarding the failure to carry out the run properly. Also, where the vehicle has a breakdown or requires additional fuel/herbicide in the middle of the run requiring it to discontinue the run for repairs/fill ups, the user and/or management/supervisors can identify exactly where in the geographic area being treated that spraying had stopped and thus can direct the spot spraying vehicle either autonomously or manually to the stoppage location to begin spraying again.

As illustrated in FIG. 22, the live run computing interface 218 can also include various other run summary statistics such as total weeds detected, total herbicide sprayed, the geographic area currently covered, the application rate, and/or a calculation as to how much herbicide has been saved relative to a blanket spray of the geographic area. The ability to see how much herbicide has been sprayed during the run may also let the user monitoring the run know when the tank containing the herbicide may be running out and plan accordingly.

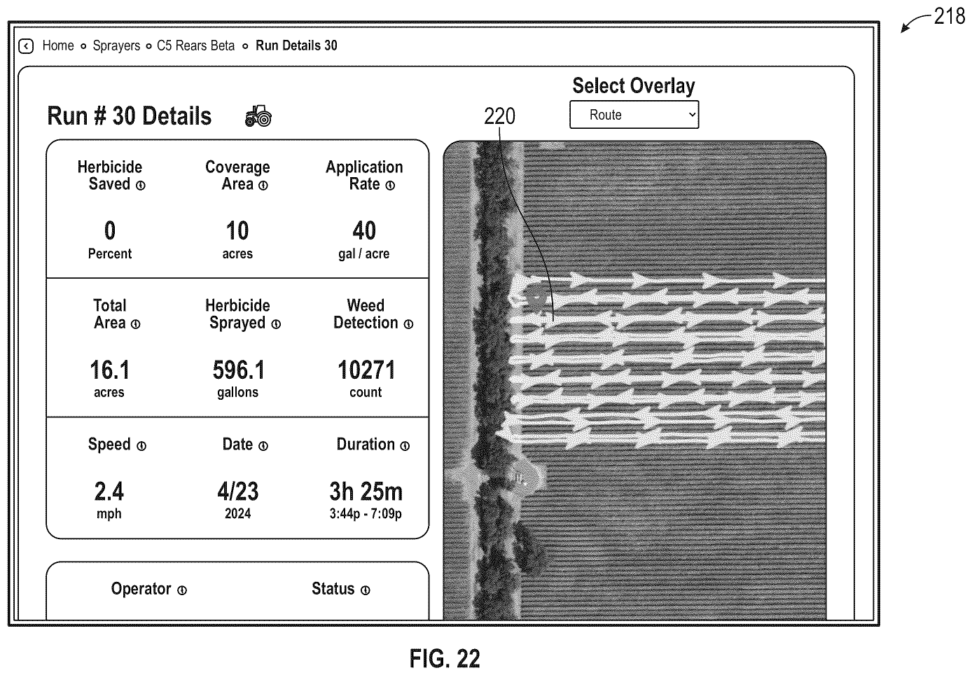

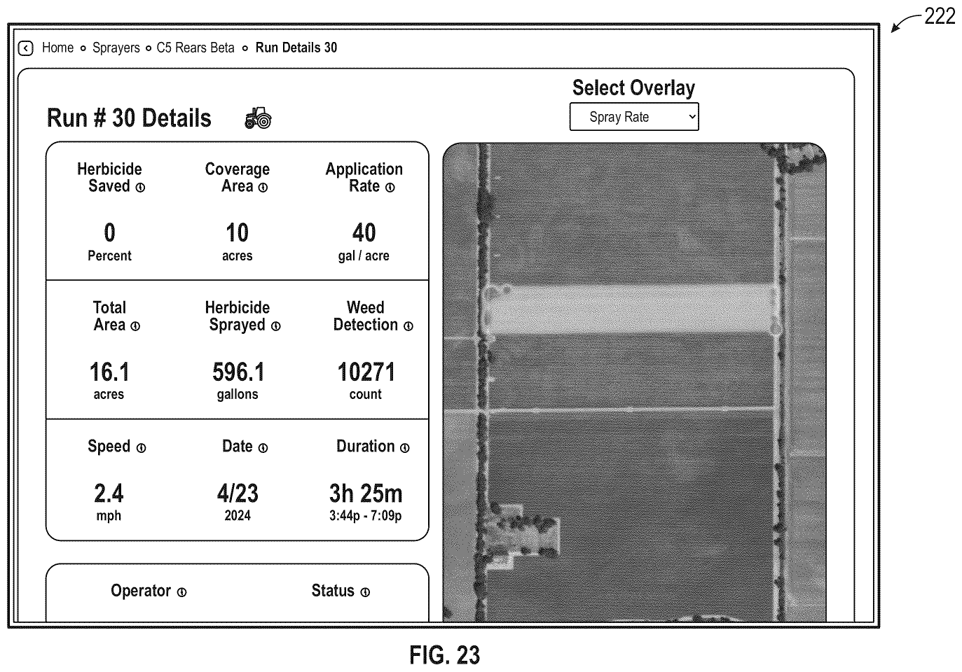

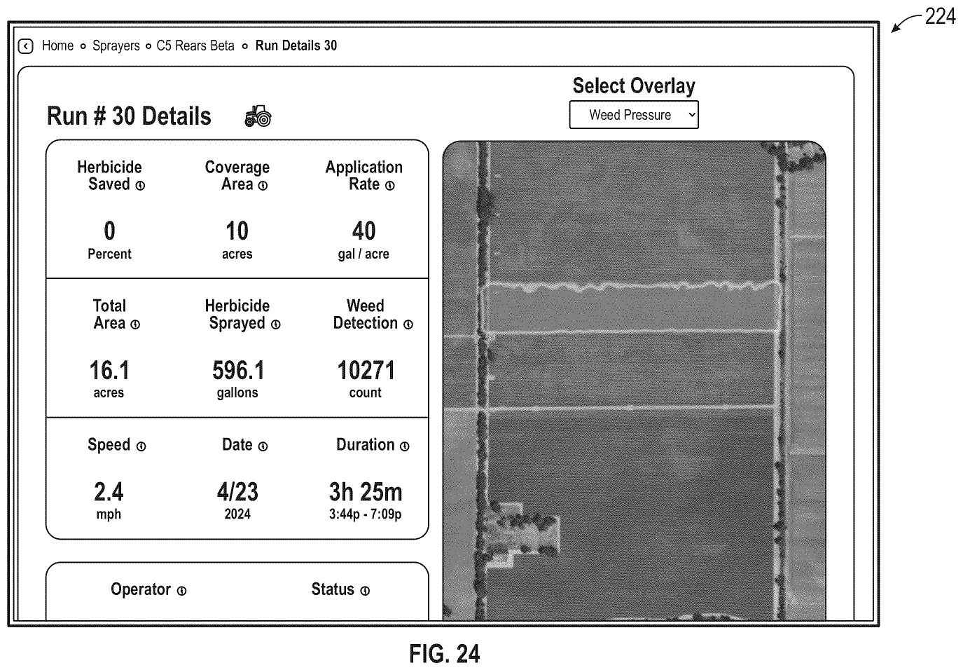

Referring to FIG. 23, another live run computing interface implementation 222 that permits the user/management to observe progress of the spot spraying vehicle during the run is illustrated. Here, a visual representation of the spray rate using a heat mapping approach of varying color by application rate is shown overlaid on a visual (here satellite) photo of the geographic area being treated. This ability to see the spraying rate helps with identifying problem areas in the geographic area that may need further treatment along with other areas that may indicate equipment failures (no spray zones) that may need on-the-ground verification to ensure that respraying is not needed. FIG. 24 is another live run computing interface implementation 224 that permits the user/management to observe weed pressure, or the amount of weeds per a specified geographic area within the geographic area during a run. Here the weed pressure is shown using a heat map of GPS coordinates of identified weeds overlaid onto the corresponding geographic locations on the visual photo of the geographic area. The weed pressure is an indication that the weed sensor(s) are operating correctly and can also indicate problem areas in the field that may need more follow up/cultivation.

Various spot spraying systems do not generally allow for data collection of the location of weeds sprayed (via GPS coordinates) and also cannot return image data of the weeds identified because the chlorophyll fluorescence sensors used do not generate high quality enough images of the weeds to permit visual identification of the weed species. The systems previously described include one or more cameras that are designed to capture images and/or video of the weeds during a spraying run and transmit the data associated with the images and/or video, including the GPS coordinates to the computing system for storage in the various databases for additional offline processing. In particular method implementations, the detection by the chlorophyll fluorescence sensor of a weed results in sending an image acquisition trigger (trigger signal) to the camera, either from the data acquisition unit, from the spray controller, or from the chlorophyll fluorescence sensor itself. In such implementations, the field of view of the camera is calibrated so that it can substantially capture the weed currently being observed by the chlorophyll fluorescence sensor.

In other implementations, however, the camera may be operating continuously collecting continuous video data while providing video data to the data acquisition unit that operates a weed recognition and identification process with the video data that works to first identify a weed and then collect a image/video data of the weed in substantially real time. The image/video data can then be sent to the computing device over the wireless telecommunication system for further processing so that the weed can then be actually identified by species and/or type. In this method implementation, the camera operates independently from the chlorophyll fluorescence sensor. In some implementations where recognition of the weed location is good enough using the camera alone, no chlorophyll fluorescence sensor may be used to direct the spot spraying. In yet other implementations, the camera may be operating by taking images at a time interval that is determined by a calculated speed of the ground vehicle. The faster the calculated speed, the shorter the time interval to ensure that images are taken at a constant distance apart as the ground vehicle travels along a certain path. In various implementations, the calculated speed is determined using global positioning coordinate data received by the global positioning sensor included in a data acquisition unit or central control unit that forms part of the sensing system attached to the ground vehicle. The process of determining the calculated speed using the global positioning data may in some implementations, involve sampling global position coordinate data at a specific rate and determining a distance traveled between each set of samples. The speed can then be calculated by dividing the distance traveled by the time between the samples.

This ability of the system and camera to collect images of the weeds at the spray locations and use the data acquisition unit to transmit the images to the computing system across the wireless telecommunication channel allows the system and method implementations to implement various methods of weed identification and reporting. These methods may be implemented using various systems in combination with the local or cloud computing system designed to implement machine learning techniques including various neural network types. In a particular implementation, the computing system may include an artificial intelligence model marketed under the tradename GEMINI by Google LLC of Mountain View, California. The machine learning works to allow the system to learn how to perform accurate identification of weed types growing in a specific geographic region that is part of a farm or other agricultural facility which is undergoing the spot spraying performed by a spot spraying vehicle like any disclosed in this document. In some implementations, however, the artificial intelligence model may be sufficiently trained (contain enough model parameters) already to accurately identify weeds well enough to be utilized without further weed image training.

In various implementations, deep learning models may be deployed at the edge device (computing system) that have been trained on both chlorophyll fluorescent datapoints and image datapoints together to detect weeds in the weed images. The deployment at the edge may involve the single board computing system prompting the artificial intelligence model directly where the artificial intelligence model is onboard the central control module whether implemented on the single board computing system or another computing system in or associated with the central control module. Examples of artificial intelligence models that can be employed at the edge may include deep learning models such as those marketed under the tradename YOLOv9 (you only look once) by Ultralytics Inc. of Frederick, Maryland; the tradename HUGGINGFACE by HuggingFace of Paris, France; LLAMA-3 by Meta of Menlo Park, California; CHATGPT by OpenAI, Inc. of San Francisco, California; and GEMINI or GEMMA 3 by Google AI of Mountain View, California. Each of these are all pre-trained deep neural networks that provide the computing/sensing system the ability to conduct a process called transform learning whereby the model that has already been trained on millions of images across 20+ classes such as the COCO, or iNaturalist dataset. Each of these models can be further trained on new images and custom categories using a process called pruning. During pruning, a transformer model is trained using labeled data that has been collected not only from the image data from the data acquisition unit but also integrated with output chlorophyll fluorescent datapoints from the chlorophyll fluorescence sensor. In the training process, a database of chlorophyll fluorescent plant fingerprints as well as images are used to further train an already robust image detection model thus keeping the previous knowledge in the model gained from billions of images and adding a new knowledge base of datapoints and categories for plant life, i.e., specific weed types on a specific farm/agricultural facility.

Since the analysis of the images proceeds offline, the data acquisition unit/central computing unit in the sensing system attached to the spot spraying vehicle does not have to include the computing hardware and computing performance to actually store and perform the data analysis required to carry out the learned identification. Because of this, the system is able to leverage the computing power of the computing system for these tasks and reduce the costs of the components of the data acquisition unit. In some implementations, however, edge use of the models may successfully use the models in real-time using the resources of data acquisition unit or central control unit.

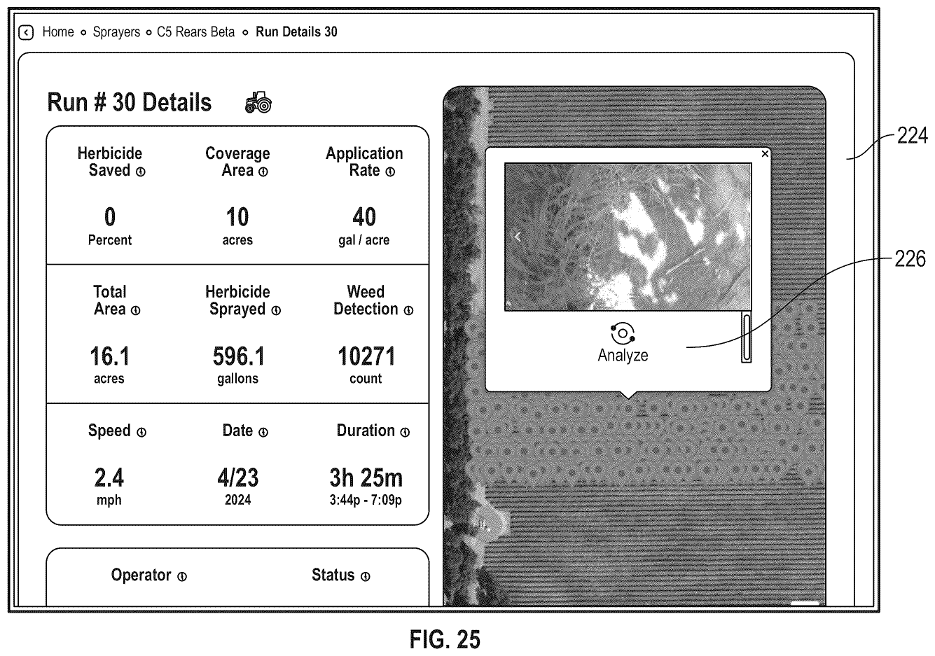

In various method implementations, the actual processing needed to perform identification of each weed image transmitted and stored during a run is not carried out until specifically requested by a user and/or requested at the end of a run. In such implementations, as illustrated in the weed analysis computer interface 226 of FIG. 25, the interface shows the location of each weed via a location indicator (here a pin) which the user can then select using the computing device. In response to the selection, the computing device retrieves the image of the weed and includes it in a display 226. As the user may already be able to identify the weed simply from the image, the ability to not have the system automatically perform recognition on each image can reduce the overall processing load and demand on the computing system to which the computing device associated with the user is operatively coupled with. As illustrated in FIG. 25, the user has the option to press an “Analyze” button to request that the computing system perform identification using the artificial intelligence system. FIG. 26 shows the weed analysis computing interface 226 with the results of the analysis underneath the image of the weed. Here, the common name of the weed with corresponding information is displayed, but in various other implementations, the scientific name and other information (treating information, propagation/spreading information, etc.) could also be included. In this way the user can get a positive identification of the weed type at that specific location in the field.

In some computing interface implementations, the interface that displays the weed identification results may include a button and/or form that allows the user to indicate agreement or disagreement with the identification displayed and, in some implementations, enter a different identification. When the user saves/transmits the agreement/disagreement/new identification, the computing system stores that information with the weed image for use in subsequent training/retraining of the neural network/artificial intelligence model implemented to assist with improving identification accuracy over time. Since the same weed species growing on different farms may have markedly different visual characteristics due to differences in soil conditions, soil types, water availability, etc. but still be the same weed species, the ability for the user to provide input for ongoing training to the computing system may be an important ability for improving weed type recognition at a particular farm or agricultural facility.

In various implementations, instead of having image recognition take place on demand from the user in response to the user selecting a particular pin and manually requesting it, all or a predetermined subset of the weed images may be processed for weed type recognition during or after the run to allow for storage of the weed types along with the weed images from the run. In such implementations, the computing system may provide reporting on the breakdown of the particular types of weeds observed and include displays of the locations of the various weed types within the geographic area being treated, either in real-time or after the run has been completed. The displays in the computer interfaces may include the ability to filter by weed type and may also include the ability to show “unknown” or “indeterminate” weeds to allow the user to select their pin locations, observe the weeds, and enter in an identification. In some interface designs, the user may have the ability to send the weed images to an agronomist associated with the system for further analysis/identification. In some implementations, particularly problematic weed types may be represented in the display with different colors or different shaped pins so that attention to them can be specifically drawn. This may be particularly useful where the particular herbicide that was applied during the run is less effective or not effective at all against that particular type of weed, meaning the user will need to conduct another run with a different herbicide, or direct workers to those specific GPS locations to manually remove/treat the weeds. Because the GPS coordinate of every weed is also stored, it is possible for the user to manually “walk” the run and perform verification of the weed types. This may be particular useful during early training/setup of the weed identification systems and methods.

In various implementations, when the user is seeking information from an agronomist, either through sending weed images using the interfaces previously described or through clicking/selecting the tile “Agronomist” in FIG. 19, or through clicking an additional tile labeled “AI Farm Assistant,” a chain or series of neural network outputs can be connected together for greater accuracy and recommendation power. When a weed is detected using a trained neural network using a YOLOv9 transform model, the output label of this model can then be passed to a Large Language Model (LLM) such as GEMINI, ChatGPT or Llama-3 (or any other model type disclosed herein) that leverages a prompt input to actuate a response appearing as a personal assistant in textual format in order to create a simulated AI Farm Assistant. Programmed prompts are leveraged to enrich the data output of the edge detection models to provide an experience of a live agronomist inside the “AI Farm Assistant” tile. The AI Farm Assistant pairs the ability of on-ground data collection through the data acquisition module with local machine learning detection and forwards the label to the large language model in the web app that further enriches that input to provide detailed solutions for discovered issues. Additional models that can be created to advise the user can be used to, by non-limiting example, detect/identify animal pests such as gophers, detect/identify insect pests such as snails, broken irrigation pipes through water pool detection using various sensors, drawing conclusions from observations of plant necrosis detected through chlorophyll fluorescent sensors during a run, assisting with equipment troubleshooting, or for helping the user with any of a wide variety of farm/agricultural facility tasks. The combination model outputs provide a multi-modal method for on-farm issue detection and resolution accessible using an “AI Farm Assistant” tile added to the group of tiles illustrated in FIG. 19.

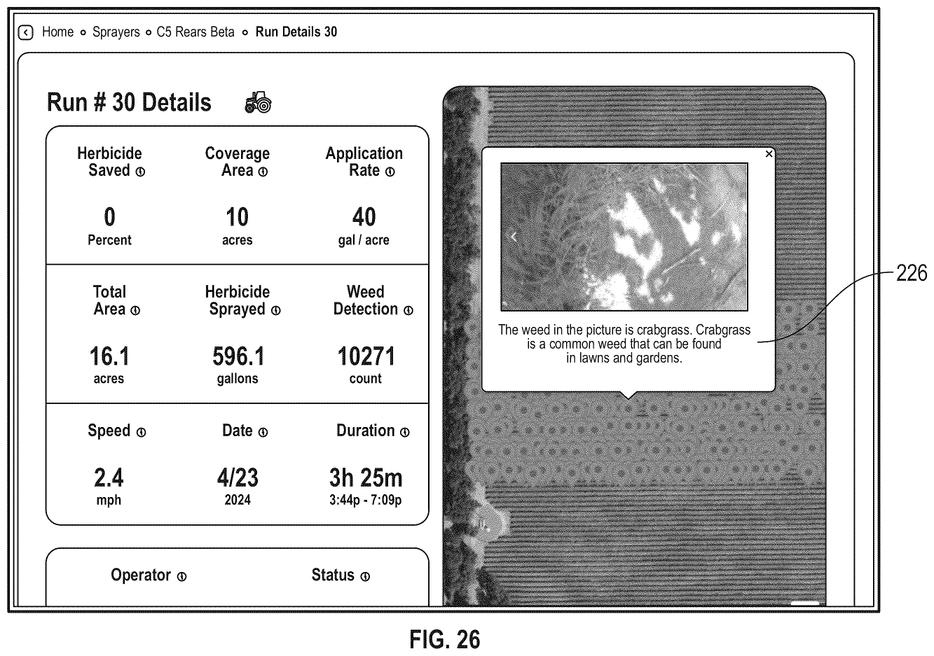

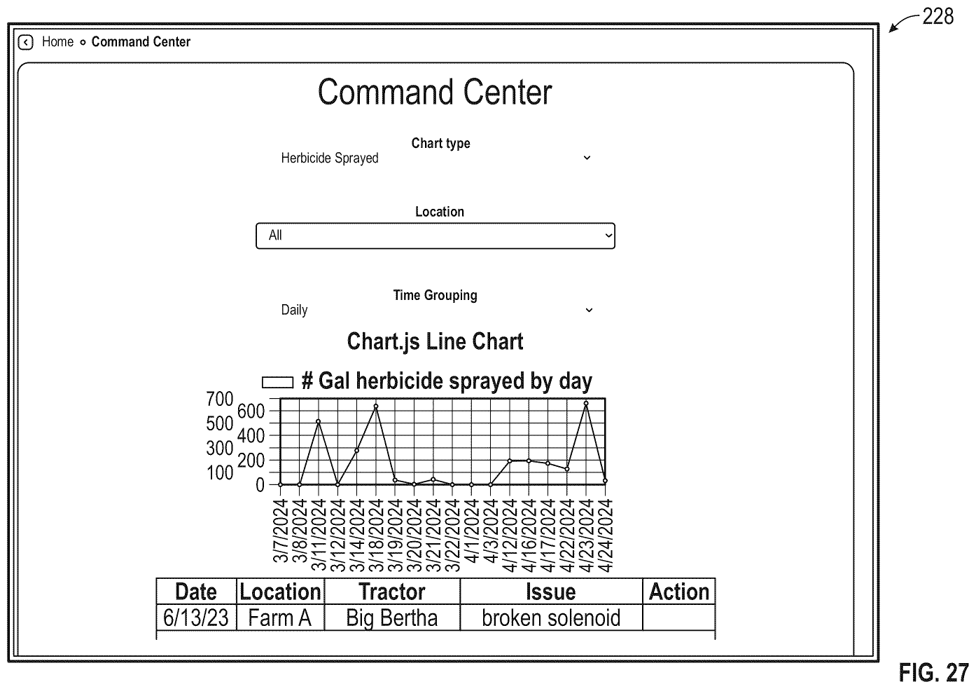

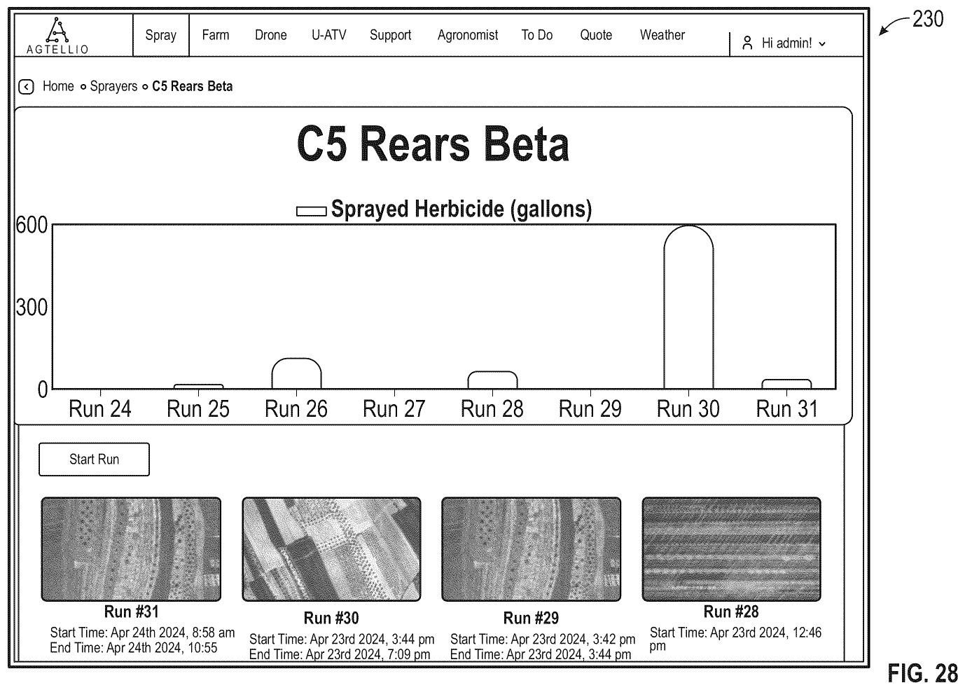

Referring to FIG. 27, an implementation of a reporting interface 228 is illustrated. In this interface design, the total consumption of herbicide is displayed along with a table listing identified issues with the various spot spraying vehicles and needed actions. This reporting interface can let the user/management track expenses and ensure that equipment issues are being addressed in a timely manner so that spraying activity remains on track. A wide variety of other data rollups and reports may be included, like the bar chart displayed in the reporting interface 230 of FIG. 28, which shows the amount of herbicide sprayed by run. This view allows the user to see areas of the farm/agricultural facility that have more significant weed problems than others. Displays of previous runs in tile form can also be included to allow the user to review the results of the various runs.

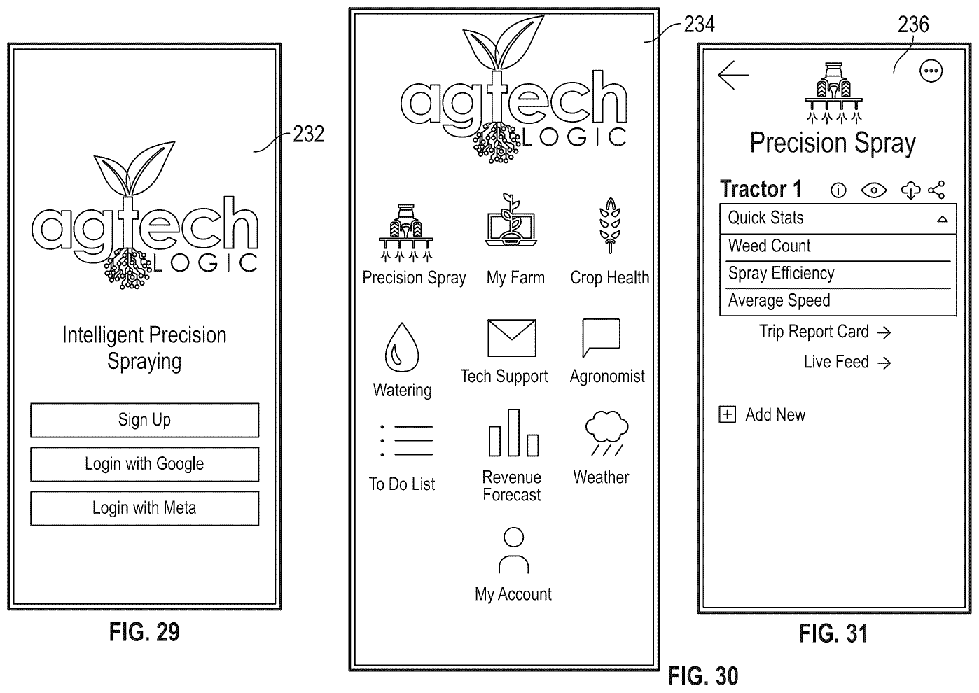

The previous interface designs in FIGS. 19-28 were formatted for display on a web page, computer screen, or portable computing device like a tablet. However, the computer interfaces may also be adapted for use with a portable computing device like a smartphone or cell phone. In such implementations, the functionality of the application may be adapted to include different/more features to allow a farmer to manage various aspects of farm/agricultural facility operations. FIG. 29 illustrates a sign in screen 232 which allows the user to create an account and enter identifying information for the farm/agricultural facility. Various set up data collection (GPS coordinates, equipment types, crop types, etc.) may also be carried out using subsequently displayed computer interfaces generated by the portable computing device. FIG. 30 illustrates a main user interface 234 similar to that of FIG. 19 but with different functionalities illustrated that are accessible through the user selecting a particular tile.

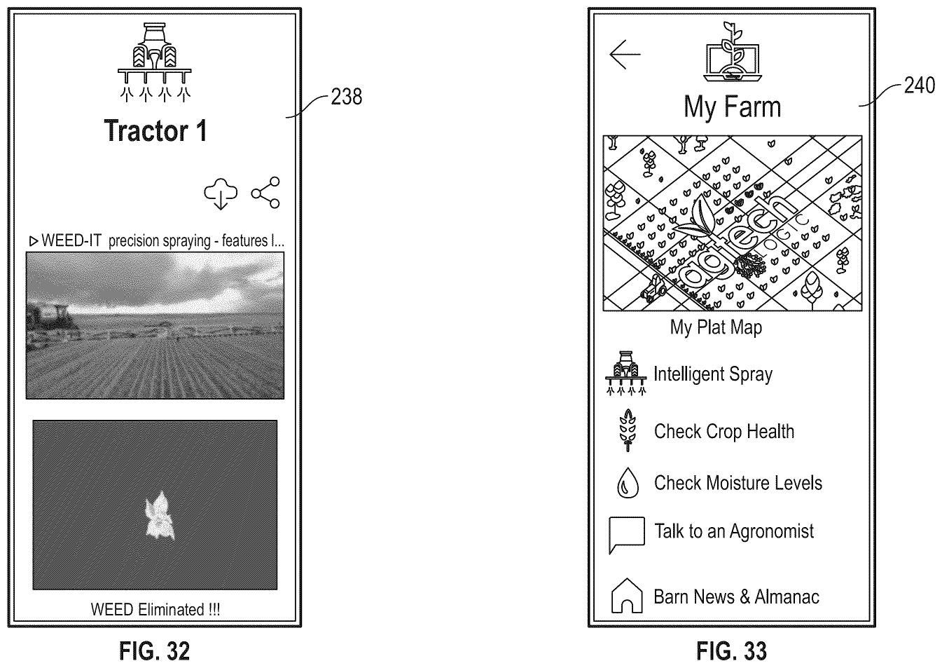

FIG. 31 illustrates a spray computer interface 236 following selection of the “Precision Spray” tile in the interface of FIG. 30. In this spray interface 236, the ability to pull up reports of an ongoing run being performed by the spot spraying vehicle are illustrated with the “Quick Stats” table along with the ability look in and see a live feed of data (video, image, or progress across a geographic area similar to the interfaces of FIGS. 22-25). The ability to add a new spot spraying vehicle and to start a new run using methods similar to those previously described is also illustrated. FIG. 32 illustrates an example of a live feed/live run interface 238 showing a location in a geographic area (here a field) along with an image of the last eliminated weed as gathered from the chlorophyll fluorescence sensor.

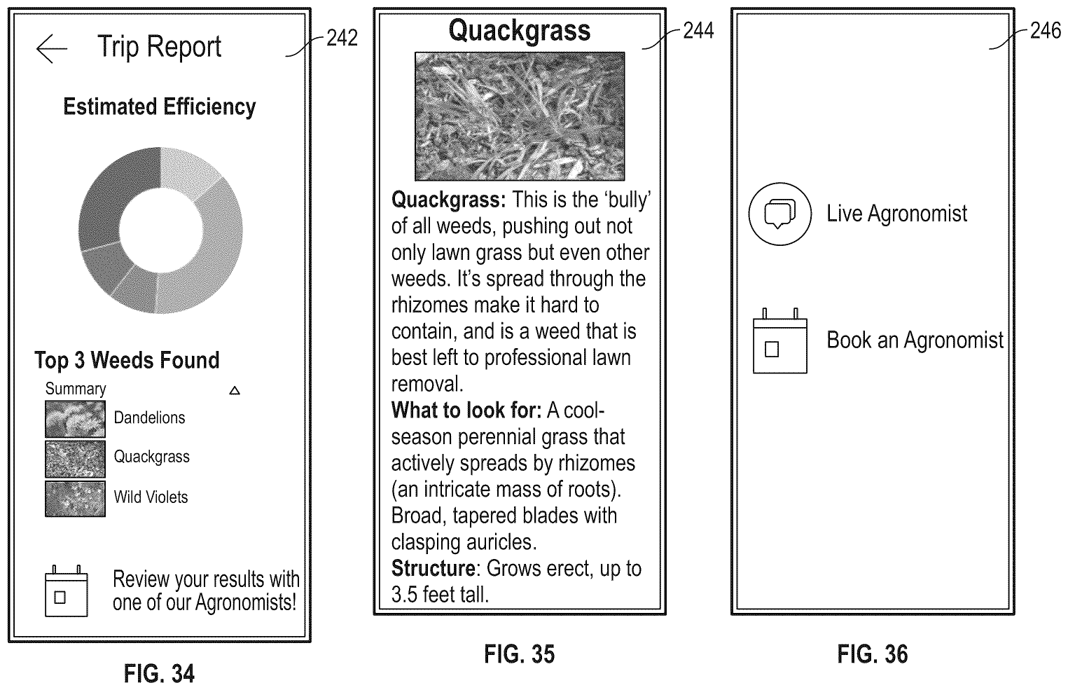

Additional computer interfaces may allow the farmer to access farm information and data in various ways. FIG. 33 shows a farm management interface 240 generated by the computing device when the “My Farm” tile is selected from the computing interface of FIG. 29. FIG. 34 illustrates a weed reporting computing interface 242 generated in response to selecting the “Trip Report Card” option from the interface of FIG. 31. This computing interface 242 includes a rollup of the top weed types identified from the weed images taken during the spot spraying run. In this implementation, to generate this rollup, the computing system had already performed weed recognition on all of the weed images during the run and stored the associated information in the various databases associated with the computing system. The ability to review the results with an agronomist by selecting a tile/option is also illustrated.

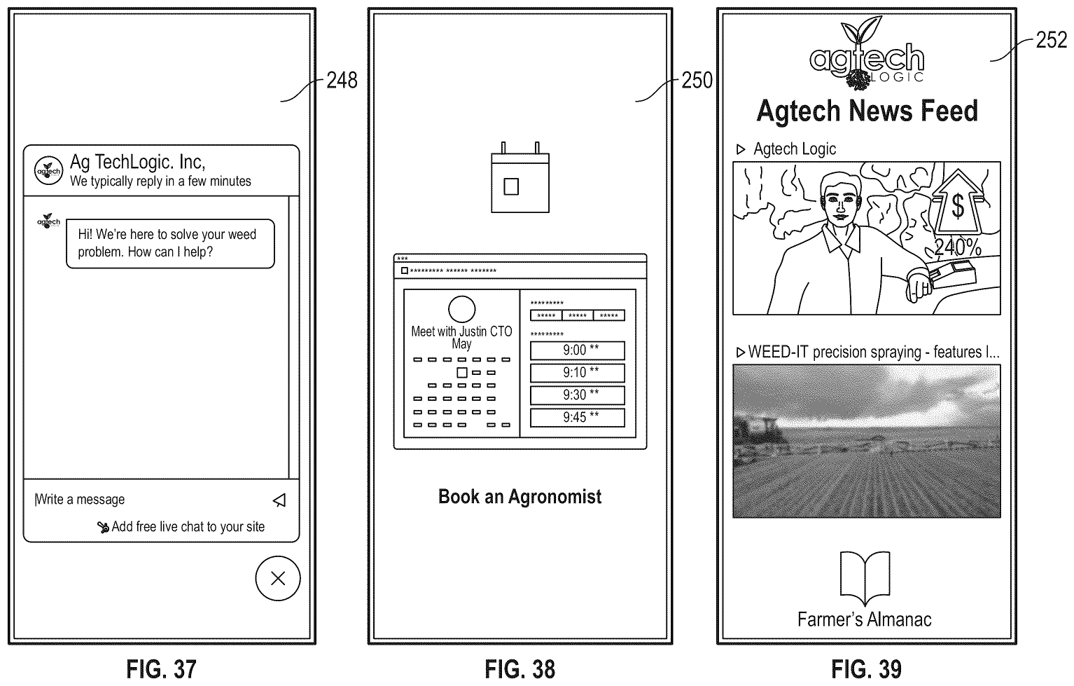

FIG. 35 illustrates an implementation of a weed information computer interface 244 generated by response to the user selecting the “Quackgrass” tile from the “Top 3 Weeds Found” table in the interface of FIG. 34. This weed information computer interface 244 provides identifying information, treatment information, and other information regarding this specific weed to the user. FIG. 36 illustrates an agronomist contact computer interface 246 that is generated by the computing device when the “Agronomist” tile is selected in FIG. 30. This interface gives the user the ability to access an agronomist via chat, generating the farmer assistant interface 248 illustrated in FIG. 37 when the “Live Agronomist” option is selected or via setting an appointment, which generates the agronomist scheduling interface 250 illustrated in FIG. 36 when the “Book an Agronomist” option is selected. In various implementations, the “Agronomist” tile may launch any of the features previously described for the “AI Farm Assistant” tile with respect to the interface implementation of FIG. 19. In such implementations, generative AI is integrated to create a virtual agronomist the farmer has access to and can even respond to verbal questions such as “Hey Agronomist, how do I kill quackgrass?”

FIG. 39 illustrates a news feed computer interface 252 that allows for transmission of relevant information, data, and user helps in a feed format along with allowing for access to a farmer's almanac of predicted weather and other information through the application. In this way, the user is able to keep up to date of relevant local and national market events along with receiving advisories and instructions about the system from the various manufacturers of the equipment. Various other interfaces may be developed that display real time and predicted weather information, provide information on crop health gathered during spot spraying and other operations, and provide employee location information, among many other things.

The various spot spraying vehicles and related systems disclosed herein may utilize various methods of identifying a weed during a spot spraying operation. The method includes using a processor included in a data acquisition unit to receive a weed detection signal from a chlorophyll fluorescence sensor. The processor may be any processor type disclosed in this document in any computing device disclosed in this document that is designed to receive data from a chlorophyll fluorescence sensor. The method also includes sending a trigger signal to a camera in response to receiving the weed detection signal. In some method implementations, the chlorophyll fluorescence sensor itself may send the trigger signal directly to the camera, which may be any camera type disclosed in this document. The method also includes receiving a weed image from a field of view of the camera in response to the trigger signal and storing the weed image in a memory included in the data acquisition unit. The method also includes recording a GPS coordinate of the data acquisition unit at the time of sending the trigger signal with the weed image in the memory. In some method implementations, the GPS coordinates may be of the camera itself where the GPS receiver is mounted to/near the camera rather than being mounted in the data acquisition unit.

The method implementation also includes transmitting the weed image and the GPS coordinate to a computing system across a telecommunication channel. The computing system may be any disclosed in this document and the telecommunication channel may be a wireless telecommunication channel. With a portable computing device like any disclosed in this document that is in communication with the data acquisition unit and with the computing system, the method includes generating a computer interface showing the location of the weed image in a geographic area being spot sprayed. The method also includes receiving from a user a selection of the location of the weed image and generating a computer interface that includes the weed image. The method also includes receiving from the user a selection requesting analysis of the weed image to identify a weed type of a weed in the weed image and transmitting an analysis request to the computing system. The method also includes receiving from the computing system a result of the analysis of the weed image including a weed type from the computing system. In various implementations, any of the system implementations, including artificial intelligence systems implementing trained models configured to identify various weed types may be utilized. The method also includes generating a computer interface that includes the weed image and the analysis results for viewing by the user.

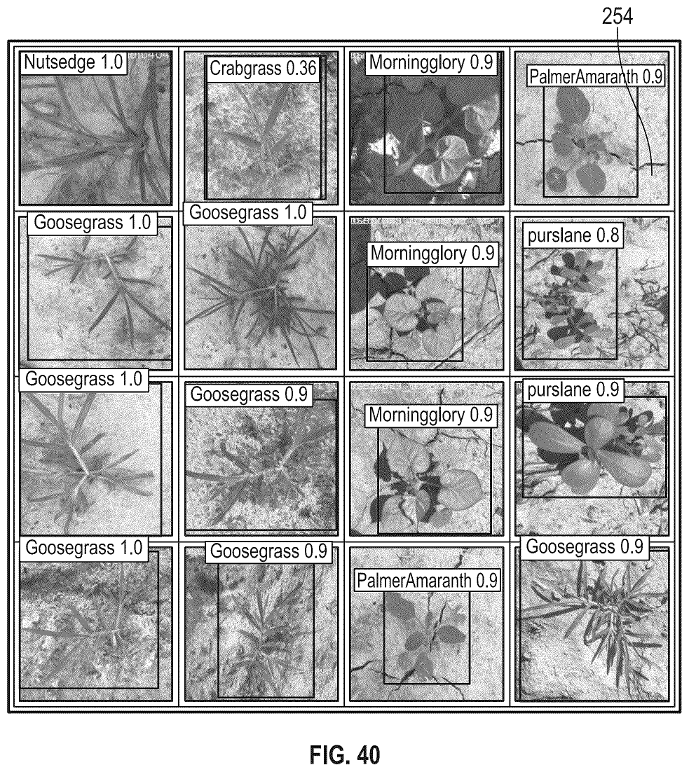

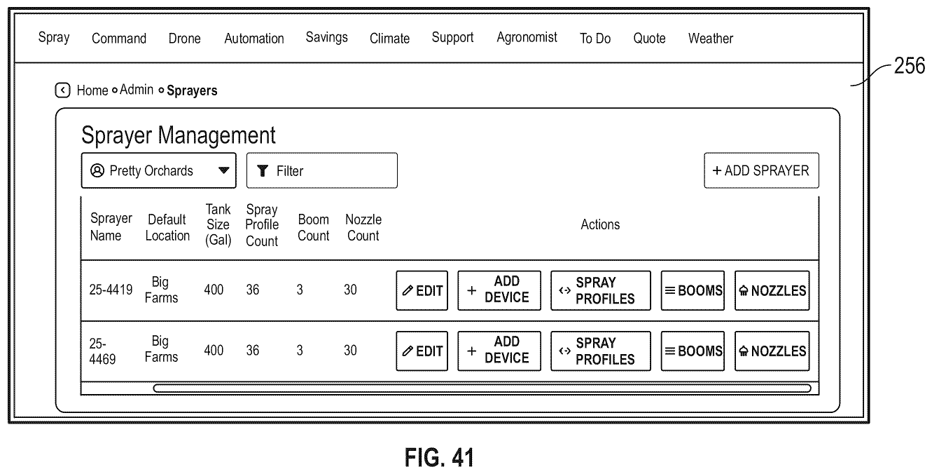

Referring to FIG. 40, an implementation of a weed image evaluation interface 254 is illustrated. In this interface, various images of weeds are illustrated each with a matching score provided by an artificial intelligence model. The artificial intelligence model calculates the match based on its pre-trained data and the weed image evaluation interface allows the user to determine whether the artificial intelligence model's recommendations are correct or not. During set up of various sensing systems in various parts of the country, weed image evaluation interfaces may be used by users to establish a “ground truth” and validate the accuracy of the particular artificial intelligence model being utilized.

As previously discussed in this document, the particular configuration of a spot sprayer can be entered into the sensing system using various computer interfaces. The configuration of the sprayer is important because calculations like the savings of herbicide, for example, depend on the sensing system knowing ahead of time how many spray nozzles are present, the pattern of the nozzles, the width of the nozzles apart from each other, the width of the spray boom, and other parameters. In various system implementations, several computing interfaces may be utilized to help with setting up a new sprayer and related equipment so the proper calculations can be performed by the computing system and/or the sensing system attached to that equipment.

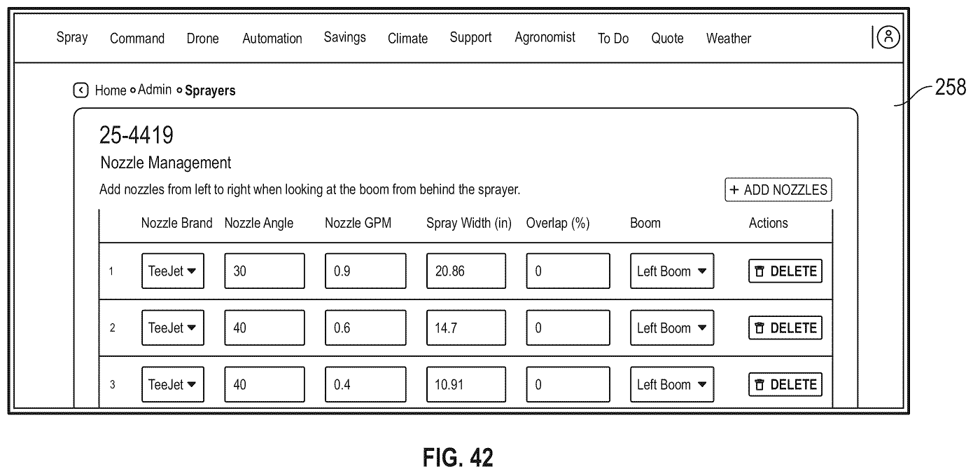

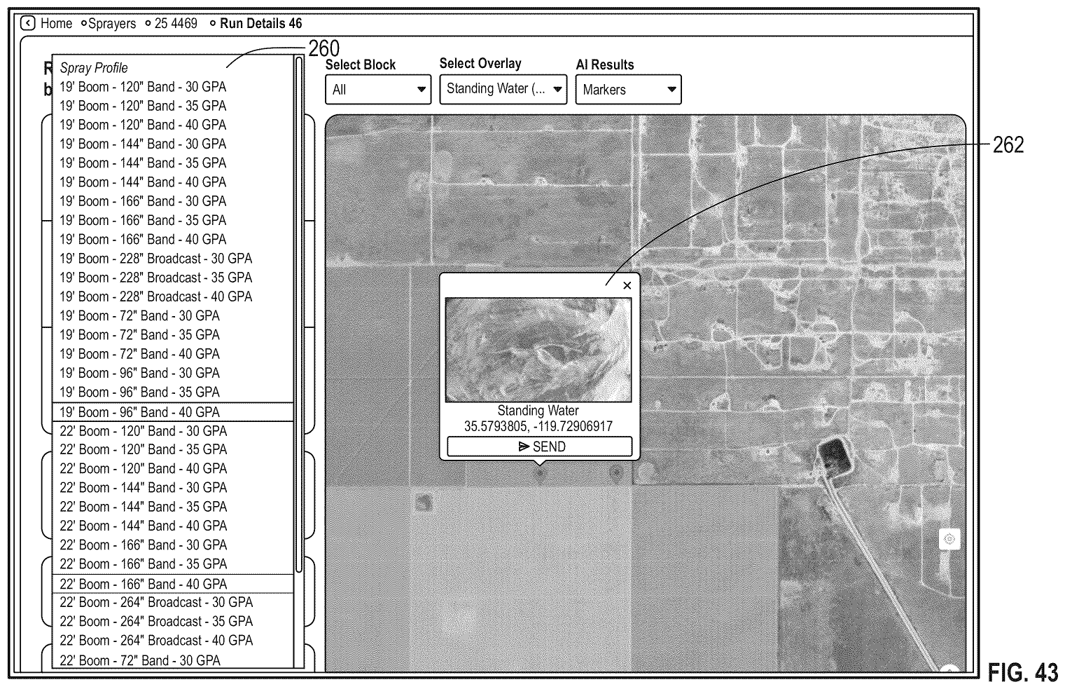

Referring to FIG. 41, an implementation of a sprayer management interface 256 is illustrated that illustrates a list of existing sprayers and includes various buttons to add a sprayer, add a device for a sprayer (like a tank), set spray profiles for a device, enter spray boom information, and adjust/select nozzle parameters. Referring to FIG. 42, another implementation of a sprayer management interface 258 is illustrated which shows the interface generated when the nozzle parameters button is clicked. Here the brand of a nozzle, nozzle angle, nozzle gallons per minute of discharge, the spray width of the nozzle, any overlap percentage between nozzles, and which boom the nozzle is installed on are all selectable and configurable. In various system implementations, a database of nozzle types and other sprayer configuration information may be included which is used to populate these computer interfaces. After a sprayer has been set up, the system also includes the ability to adjust the parameters even after a run has been completed as illustrated in sprayer configuration interface 260 of FIG. 43 which shows a drop down menu that allows for changing of the spray profile for the sprayer.

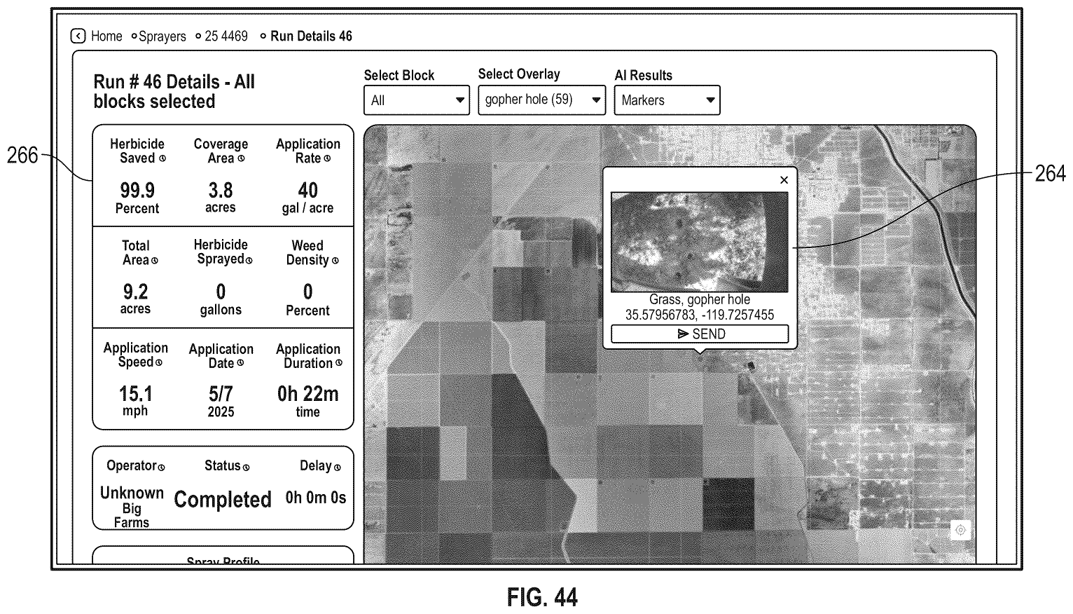

FIG. 43 also illustrates on the right an implementation of a queueing interface 262. One of the functions of the various sensing systems implementations is the ability to scout other issues than weeds during a spot spraying operation (or while simply traversing a path across a desired geographic area of an agricultural facility). In FIG. 43, the camera has captured an image as it has been taking pictures while traversing at the predetermined rate previously discussed. The image has been included in a prompt which has been provided to an artificial intelligence model operatively coupled with the single board computing system and the cloud computing system associated with the sprayer. The queueing interface 262 shows the results of the recommendation provided by the artificial intelligence model and the global positioning coordinates of the image. Since the type of the image is standing water, indicating an irrigation leak in the path of the sprayer, the system generates the queueing interface 262. Beneath the recommendation is a button marked send, which allows the user, when selected, to send the image and the global positioning coordinates thereof to one or more persons who will then manually go out to resolve the issue. In other implementations, however, where the issue could be resolved using an autonomous vehicle the send button schedules a trip/run for the autonomous vehicle as soon as it is ready to proceed or at a specific time. The specific time may be set by the user or by a schedule for the various autonomous vehicles used on an agricultural facility. Various priorities of tasks based on the nature of the problem revealed by the image may also factor into the scheduling timeframe/decision. Examples of other items that could be used with a queueing interface include gopher holes, downed branches, other holes, rocks, or other non-weed objects. FIG. 44 illustrates another queuing interface 264 that shows an image recommended as gopher holes.

Referring to FIG. 44, an implementation of a run summary interface 266 is illustrated that includes various run summary statistics. One of these summary statistics is how much herbicide was saved during the run by using spot spraying compared with broadcast spraying. Broadcast spraying is the approach where a sprayer turns on all nozzles and traverses across an entire field while spraying at the nominal operating conditions for the nozzles to ensure that every possible weed or plant receives an effective dose of herbicide/fertilizer, etc. One of the challenges with determining and reporting savings in a spraying operation is the inability to accurately calculate exactly how much herbicide a broadcast spraying operation would theoretically expended while treating the same geographic area that was just treated by a spot sprayer. In various method implementations, a method of calculating savings includes first calculating a theoretical equivalent quantity of herbicide (fertilizer, etc.) that would have been expended had the sprayer with the current nozzle and boom configuration completed the current spraying run using broadcast spraying. In various method implementations this includes calculating a speed of the herbicide sprayer using global positioning coordinate date from a global positioning sensor included in the data acquisition unit (or central control unit) that is operatively coupled with the single board computer. The method also includes using a nozzle flow rate from each nozzle, the speed, and the total width of the spray boom of the herbicide sprayer, calculating a broadcast application rate of the herbicide sprayer. With this broadcast application rate at the total area sprayed during the run, the method includes calculating a theoretical total applied gallons of herbicide (if applied using broadcast spraying). The method then includes using a flowmeter attached to the feed line to the nozzles to measure the actual total dispensed gallons of herbicide during the run over the total area spayed during the run and calculating the percentage of herbicide saved. This is done by subtracting the actual total dispensed gallons of herbicide from the theoretical total applied gallons of herbicide and dividing by the theoretical total applied gallons of herbicide.

The amount saved is not going to be a constant amount because spot spraying techniques target each individual weed or plant sensed. Where there are more plants sensed (higher weed loading for example), more spraying will occur than if there are less plants sensed. Testing data has indicated that savings can range from 0% to in excess of 90% depending on conditions. Thus, in order to provide an accurate picture of how much spot spraying saves, an amount saved for each run needs to be calculated using the actual hardware configuration of the sprayer used for the run. Some methods of calculating savings based on some average application rate per acre for the sprayer times the number of acres compared to the measured actual total dispensed gallons of herbicide can be quite inaccurate because that average application rate does not comprehend the actual sprayer configuration (nozzles, boom width, nozzle spacing, spray pattern, overlap, etc.) nor the actual speed at which the sprayer traversed the entire geographic area. Thus the methods and systems disclosed herein which provided the actual spray configuration information and the actual speed the vehicle traveled during a specific run allow for an apples to apples comparison between a theoretical amount of herbicide that would be sprayed during a broadcast application versus the actual amount of herbicide that was sprayed using spot spraying. In this way, the farmer can know accurately, run by run, how much herbicide and how much money was saved after each run.

The various sensing system implementations and spot spraying systems disclosed herein may utilize various methods of spot spray operation. The spot spray operations may be applied to herbicide spraying, but may also apply to fertilizer spraying, insecticide spraying, watering, or delivery of any other water-based solution. In the context of herbicide spraying, a method implementation includes using an herbicide sprayer with a data acquisition unit or central control unit (or both) coupled to the sprayer while the sprayer is traversing a geographic area. The data acquisition unit may be any disclosed in this document as may the central control unit. The method includes using a single board computer included in the data acquisition unit to send a trigger signal to a camera coupled to the herbicide sprayer. The single board computer may be any type disclosed herein and the camera may also be any type disclosed herein including a POE camera. The method includes receiving an image from a field of view of the camera and with the image, prompting an artificial intelligence model operatively coupled with the single board computer to determine a type of one or more objects in the image. In various implementations, this includes where the single board computer develops the prompt and delivers it directly to the artificial intelligence model or where a cloud computing system operatively connected with the single board computer develops the prompt and delivers it directly to the artificial intelligence model. The artificial intelligence model may be any disclosed in this document in various implementations.

The method includes receiving a recommendation from the artificial intelligence model of the type of the one or more objects in the image. The artificial intelligence model may be able to detect multiple different types of objects included in the image (as in the queueing interface 264 in FIG. 44) in various implementations. Where the type of the object is a gopher hole or standing water, the method includes determining a global positioning coordinate associated with the location of the data acquisition unit or central control unit at the time of sending of the trigger signal. In some method implementations, depending on the physical configuration of the various sensing system components the global positioning coordinate may be of the camera itself or of a point within the geographic area of the field of view of the camera visible in the image itself. The method also includes storing the image and the global positioning coordinate in a memory operatively coupled with the single board computer. In various implementations this may include using a flash drive, solid state drive, or hard drive attached to the single board computer through the base board or another component or directly attached to the single board computer. If the type of the object is a weed, the method includes determining a global positioning coordinate associated with the location of the camera and storing the image and the global positioning coordinate in the memory. The method also includes sending the image to a cloud computing system, which may be any cloud computing system using any transmission method disclosed herein.

In various method implementations, sending the trigger signal to the camera includes sending the trigger signal at a time interval determined by a calculated speed of the herbicide sprayer as previously disclosed herein. In various method implementations, the calculated speed is determined using global positioning coordinates from a global positioning sensor included in the data acquisition unit or central control unit. The calculations may be according to the various examples provided herein.

The previous method implementation can take place while the herbicide sprayer is traversing a geographic area, but not necessarily spraying or in a spraying location in a scouting mode of operation. The previous method implementation can also take place while the herbicide sprayer is spraying or in a spraying location as a way of scouting and spraying simultaneously. An implementation of a method of weed detection may include receiving a a weed detection signal from a chlorophyll fluorescence sensor and sending a weed trigger signal to the camera. This may be accomplished using any of the various system and method implementations for triggering and imaging disclosed herein. The method includes receiving a weed image from the field of view of the camera in response to the weed trigger signal and storing the weed image in the memory. The method also includes determining a global positioning system coordinate of the data acquisition unit or central control unit at the time of sending the weed trigger signal and storing the global positioning coordinate in the memory. The method also includes sending the weed image and the global positioning coordinate to a cloud computing system using any method of transmission disclosed herein.

An implementation of a method of identifying a weed in a weed image includes using a portable computing device in communication with the data acquisition unit or central control unit and with the cloud computing system. The portable computing device may be any disclosed herein. The method includes generating a computer interface that shows the location of the weed image previously taken in the geographic area and receiving from a user a selection of the location of the weed image. The method also includes generating a computer interface including the weed image and transmitting an analysis request to the cloud computing system to prompt an artificial intelligence model operatively coupled with the cloud computing system to determine a type of one or more weeds in the weed image. The transmission in various implementations includes using a computer interface with an analysis button like that disclosed herein in the form of the interface of FIG. 25. The method includes receiving a recommendation from the artificial intelligence model of the type of the one or more weeds in the weed image and generating a computer interface that includes the weed image and the recommendation. This interface may take the form of the interface illustrated in FIG. 26. The artificial intelligence model may be any disclosed in this document. The method may also include storing the recommendation with the image in the cloud computing system.

Various methods of queuing action on an object detected in an image include if the type of object detected in the image is a gopher hole or standing water (or any other non-weed type object disclosed herein), the method includes using a portable computing device like any disclosed herein that is in communication with the data acquisition unit or central control unit and the cloud computing system. The method further includes generating a computer interface showing the location of the image in the geographic area, receiving from the user a selection of the location of the image, and generating a computer interface including the image including a queuing element. In particular implementations, the computer interface may take the form of those illustrated in FIGS. 43-44. The method also includes in response to the user selecting the queuing element, sending a message to one or more persons or to one or more autonomous vehicles to queue an action on the gopher hole or standing water. The message may be, by non-limiting example, an email, a notification to an application on a portable computing device, a notification in a virtual reality or augmented reality headset, a text message, or any other electronic message type. For an autonomous vehicle, the notification may include any of the scheduling options previously discussed herein.

Implementations of a method of calculating a savings of a dispensed chemical or water (like herbicide, etc.) include calculating a speed of the herbicide sprayer using global positioning coordinate data from a global positioning sensor included in the data acquisition unit or central control unit (or from the location of any other component of the system, camera, etc.) operatively coupled with the single board computer. The single board computer may be any type disclosed herein. The method includes using a nozzle flow rate from each nozzle attached to a spray boom of the herbicide sprayer, the calculated speed, and the total width of the spray boom of the herbicide sprayer to calculate a broadcast application rate of the herbicide sprayer during a run that was just completed or in process. This broadcast application rate is a theoretical broadcast application rate. With the broadcast application rate of the herbicide sprayer and the total area sprayed during a run that was just completed or in process, calculating a theoretical total applied gallons of herbicide that would have been sprayed over the total area sprayed or which would have been sprayed up to this point in the run. The method includes using a flowmeter (which may be any flowmeter type disclosed herein), measuring an actual total dispensed gallons of herbicide over the total area sprayed during the run (either at completion or up to the present time during the run in progress). The method also includes calculating a percentage of herbicide saved during the run or up to the current point in the run using the theoretical total applied gallons of herbicide and the actual total dispensed gallons of herbicide. This calculation may be done using the exemplary calculations disclosed herein. The method may also include using the portable computing device in communication with the data acquisition unit and with the cloud computing system to generate a computer interface that includes the percentage of herbicide saved during the run or up to the current point in the run.

The various method implementations disclosed herein may also employ various methods of configuration a sprayer in the system that may employ generating and receiving inputs from various interfaces that allow for setting of boom width, nozzle time, nozzle spacing, nozzle discharge rates in gallons per minute (or other units) like those interfaces in FIGS. 41-43.

The various sensing system implementations disclosed herein may also be incorporated into other types of autonomous ground vehicles which are not sprayers, but where camera data collection, speed tracking, fluorescent sensor data collection, and/or other scouting is desired. Such drive-by-wire vehicle systems can benefit from the data collection, artificial intelligence model processing, and data reporting features of the sensor systems as they traverse various geographical areas. The ability to take an existing autonomous system and integrate data collection along with data transfer to a cloud computing system associated with the sensing system or with the party who owns/controls the autonomous ground vehicle or a third party can accelerate development of autonomous agricultural vehicles that have on-board data collection and processing capability.

In places where the description above refers to particular implementations of spraying and scouting systems and implementing components, sub-components, methods and sub-methods, it should be readily apparent that a number of modifications may be made without departing from the spirit thereof and that these implementations, implementing components, sub-components, methods and sub-methods may be applied to other spraying and scouting systems.

What is claimed is:

1. A data acquisition unit for a ground vehicle comprising:
an enclosure;
a single board computer comprised in the enclosure;
a base board operatively coupled with the single board computer;
an optocoupler operatively coupled with the single board computer;
at least one chlorophyll fluorescence sensor coupled with the optocoupler;
at least one camera coupled to the base board;
a global positioning sensor coupled with the base board;
a flow meter coupled with the single board computer; and
a power source operatively coupled with the single board computer and with the base board.

2. The data acquisition unit of claim 1, further comprising wherein a wireless access point is coupled with the single board computer.

3. The data acquisition unit of claim 1, further comprising a central control unit coupled with the single board computer.

4. The data acquisition unit of claim 1, wherein the enclosure is configured to attach to an herbicide sprayer.

5. The data acquisition unit of claim 4, wherein:
the chlorophyll fluorescence sensor is configured to attach to a spray boom of the herbicide sprayer;
the at least one camera is configured to attach to the boom adjacent to the chlorophyll fluorescence sensor; and
the flow meter is configured to couple into an herbicide feed line of the herbicide sprayer.

6. A central control unit for a ground vehicle comprising:
an enclosure;
a single board computer comprised in the enclosure;
a switch comprising at least one power over ethernet port;
at least one chlorophyll fluorescence sensor coupled with the single board computer;
at least one camera coupled to the power over ethernet port;
a global positioning sensor coupled with the single board computer;
a flow meter coupled with the single board computer; and
a battery operatively coupled with the single board computer and with the switch.

7. The central control unit of claim 6, further comprising a battery charger, a battery protection circuit, a step up regulator, two or more breakers, and a transformer.

8. The central control unit of claim 6, further comprising a wire coupled to an ignition wire of the ground vehicle.

9. The central control unit of claim 6, wherein the switch further comprises a wireless access point.

10. The central control unit of claim 6, wherein:
the enclosure is configured to attach to an herbicide sprayer;
the chlorophyll fluorescence sensor is configured to attach to a boom of the herbicide sprayer;
the at least one camera is configured to attach to the boom adjacent to the chlorophyll fluorescence sensor; and
the flow meter is configured to coupled into an herbicide feed line of the herbicide sprayer.

11. A method of spot spray operation, the method comprising:
with an herbicide sprayer with a data acquisition unit or central control unit coupled thereto while the herbicide sprayer is traversing a geographic area:
using a single board computer comprised in the data acquisition unit:
sending a trigger signal to a camera coupled to the herbicide sprayer;
receiving an image from a field of view of the camera;
with the image, prompting an artificial intelligence model operatively coupled with the single board computer to determine a type of one or more objects in the image;
receiving a recommendation from the artificial intelligence model of the type of the one or more objects in the image;
if the type is one of a gopher hole or standing water, determining a global positioning coordinate associated with a location of the data acquisition unit or central control unit at a time of sending of the trigger signal and storing the image and the global positioning coordinate in a memory operatively coupled with the single board computer; and
if the type is a weed, determining a global positioning coordinate associated with the location of the camera and storing the image and the global positioning coordinate in the memory operatively coupled with the single board computer; and
sending the image to a cloud computing system.

12. The method of claim 11, wherein sending the trigger signal to the camera further comprises sending the trigger signal at a time interval determined by a calculated speed of the herbicide sprayer.

13. The method of claim 12, wherein the calculated speed is determined using global positioning coordinates from a global positioning sensor comprised in the data acquisition unit or central control unit which is operatively coupled with the single board computer.

14. The method of claim 11, further comprising:
receiving a weed detection signal from a chlorophyll fluorescence sensor;
sending a weed trigger signal to the camera;
receiving a weed image from the field of view of the camera in response to the weed trigger signal;
storing the weed image in the memory operatively coupled with the single board computer;
determining a global positioning system coordinate of the data acquisition unit or central control unit at a time of sending the weed trigger signal and storing the global positioning system coordinate in the memory; and
sending the weed image and the global positioning coordinate to a cloud computing system.

15. The method of claim 14, further comprising:
using a portable computing device in communication with the data acquisition unit or central control unit and with the cloud computing system:
generating a computer interface showing the location of the weed image in the geographic area;
receiving from a user a selection of a location of the weed image;
generating a computer interface including the weed image;
receiving from the user a selection requesting analysis of the weed image to identify a weed type of a weed in the weed image;
transmitting an analysis request to the cloud computing system to prompt an artificial intelligence model operatively coupled with the cloud computing system to determine a type of one or more weeds in the weed image;
receiving a recommendation from the artificial intelligence model of the type of the one or more weeds in the weed image; and
generating a computer interface including the weed image and the recommendation.

16. The method of claim 14, further comprising:
if the type is one of gopher hole or standing water, using a portable computing device in communication with the data acquisition unit and with the cloud computing system:
generating a computer interface showing a location of the image in the geographic area;
receiving from a user a selection of the location of the image;
generating a computer interface including the image including a queuing element; and
in response to a user selecting the queuing element, sending a message to one or more persons or to one or more autonomous vehicles to queue an action on the gopher hole or standing water.

17. The method of claim 11, further comprising:
calculating a speed of the herbicide sprayer using global positioning coordinate data from a global positioning sensor comprised in the data acquisition unit or central control unit which is operatively coupled with the single board computer;
with a nozzle flow rate from each nozzle, the speed, and a total width of a spray boom of the herbicide sprayer, calculating a broadcast application rate of the herbicide sprayer;
with the broadcast application rate of the herbicide sprayer and a total area sprayed during a run, calculating a theoretical total applied gallons of herbicide;
with a flowmeter, measuring an actual total dispensed gallons of herbicide over the total area sprayed during the run; and
calculating a percentage of herbicide saved during the run using the theoretical total applied gallons of herbicide and the actual total dispensed gallons of herbicide.

18. The method of claim 17, using a portable computing device in communication with the data acquisition unit and with the cloud computing system:
generating a computer interface comprising the percentage of herbicide saved during the run.

19. The method of claim 11, wherein prompting the artificial intelligence model further comprises prompting using the single board computer.

20. The method of claim 11, wherein prompting the artificial intelligence model further comprising prompting using the cloud computing system.
